(19) United States
(12) Patent Application Publication
(10) Pub. No.: US 2021/0340361 A1
(43) Pub. Date: Nov. 4, 2021

(54) Crosslinked Elastomer-Polymer Blends

(71) Applicant: ExxonMobil Chemical Patents Inc., Baytown, TX (US)

(72) Inventors: Krishnan Anantha Narayana Iyer, Manvel, TX (US); Antonios K. Doufas, Houston, TX (US); Krassimir I. Doynov, Houston, TX (US); Anthony J. Dias, Houston, TX (US)

(21) Appl. No.: 17/278,575

(22) PCT Filed: Sep. 10, 2019
(86) PCT No.: PCT/US2019/050303

§ 371 Date: Mar. 22, 2021

Related U.S. Application Data
(60) Provisional application No. 62/735,563, filed on Sep. 24, 2018.

(51) Int. Cl. C08L 23/06; B32B 1/08; B32B 15/18; B32B 25/14; B32B 15/06; F16L 11/10

(52) U.S. Cl. CPC C08L 23/06; B32B 1/08; B32B 15/18; B32B 25/14; B32B 2307/558; F16L 11/10; C08L 2203/18; C08L 2205/03; B32B 2597/00; B32B 15/06

(57) ABSTRACT

Embodiments of the present disclosure generally relate to crosslinked TPE or TPV compositions, flexible pipes containing crosslinked TPE or TPV compositions, and methods for forming crosslinked elastomer polymer compositions and flexible pipes. In an embodiment, a flexible pipe includes a plurality of layers, where at least one layer includes a composition including: at least one polar elastomer, and a polymer having a crystallinity of about 20% or greater. In an embodiment, a pipe includes an inner sheath, an outer sheath, a first armor layer, and a second armor layer, where at least one of the inner sheath and the outer sheath comprises a crosslinked TPE or TPV composition that is the reaction product of an elastomer having a polarity of about 90° or less, a polymer having a crystallinity of about 20% or greater, and a crosslinking agent.

### PRIORITY

This application claims priority to U.S. Provisional Application No. 62/735,563, filed Sep. 24, 2018, the disclosure of which is incorporated herein by reference.

### FIELD

Embodiments of the present disclosure generally relate to crosslinked elastomer-polymer blends, flexible pipes containing crosslinked elastomer-polymer blends, and methods for forming crosslinked elastomer polymer blends and flexible pipes. The present disclosure further relates to processes for crosslinking compositions during extrusion of a flexible pipe such as those used in offshore hydrocarbon production.

### BACKGROUND

Flexible pipes are used to transport fluids between oil and gas reservoirs and platforms for separation of oil, gas and water components. The flexible pipe structures include layers of materials, the layers being, for example, polymeric, metallic, and composite layers. For fluid containment, conventional flexible pipes include an inner pressure sheath (a polymeric sheath) which contacts the fluids being transported in the flexible pipe. Because the inner pressure sheath contacts the fluids being transported in the pipe, good resistance to physical and chemical degradation, resistance to hydrolysis, and low permeability to various gases in the fluids transported is needed.

Flexible offshore pipes having a tube-formed inner liner and at least one reinforcement layer are used for the transportation of oil and gas products over long distances and often at elevated temperatures, such as above 60° C. or more. Offshore pipes are also used for injection of chemicals into a sub-sea drilled well, e.g. connected between a host oil platform and a sub-sea satellite installation. If the pipe comprises a metal carcass, it is said to be a smooth-bore pipe. Generally for transporting hydrocarbons, a pipe including a carcass is typically used, while a pipe free from carcass is suitable for transporting water and pressurized steam. Offshore pipes should be capable of operating at high pressures, and the pipes should be resistant to chemicals and water, including seawater. Furthermore, such offshore pipes should be flexible so that they can be spooled onto a drum or reel. For example, offshore pipes are normally very long having so-called risers often several hundred meters long and so-called flow-lines often several kilometers long. They are laid on the seabed, typically subjected to high pressures and pressure differences along the pipeline. While the pipeline is transporting oil or gas, the pipelines may be exposed to temperatures substantially above 60° C. Specifically, these pipes are of the unbonded type and they are described in documents including the American Petroleum Institute (API), API 17J and API RP 17B.

The flexible pipes may be used at a great depth, typically down to 2,500 meters of depth and advantageously down to 3,000 meters. They allow transport of fluids, notably of hydrocarbons, having a temperature typically attaining 130° C., which may even exceed 150° C., and having an internal pressure which may attain 1,000 bars, or even 1,500 bars.

Offshore pipes generally comprise one or more tube-formed barrier layers including an inner liner and at least one reinforcing layer. The inner liner is the innermost polymer layer, which in known offshore pipes also constitutes a barrier layer or a pressure sheath, and which is exposed to a fluid, e.g. oil transported in the pipeline. In most situations, the pipeline also comprises an outer sheath providing a barrier to the outer environment such as seawater. The pipe normally comprises one or more reinforcing layers between the inner liner and the outer sheath, and some pipes also comprise a reinforcing layer inside the pipe, called a carcass. The carcass prevents collapse of the inner liner and provides mechanical protection to the inner liner. Some pipes also comprise one or more intermediate polymer layers.

The inner polymeric pressure sheath should be chemically stable and mechanically strong even when subjected to high temperatures and pressure. The material useful as pressure sheath should have a good balance of ductility/flexibility, resistance over time (generally the pipe should have a lifetime of at least 20 years), and mechanical strength to heat and pressure. The material should also be chemically inert towards chemical compounds of the transported fluid. Typical offshore hydrocarbon production fluids comprise crude oil, water and pressurized gases such as CO₂ and H₂S. Furthermore, the pressure sheath should be manufactured in one piece since repair, welding or other types of connecting methods are difficult to accomplish for inner liners in offshore pipelines. The inner liner is therefore normally produced by continuous extrusion of a polymer. A number of polymers are presently used for the production of inner liners, such as Polyamide-11 (PA-11), polyethylene (PE), either crosslinked or not, and Polyvinylidene diflouride (PVDF). These materials provide heat stability, resistance to crude oil, seawater, gases, mechanical fatigue, ductility, strength, durability and processability. The inner liner material is normally selected on a case-to-case basis after careful investigation of the conditions for the planned installation. Here, crosslinked polyethylene may in many cases prove to fulfill the requirements.

However, polyamides are susceptible to hydrolysis and aliphatic polyketones are also susceptible to degradation at elevated temperatures. In addition, the permeability of gases increases with temperature, and polyethylene has a relatively high permeability and solubility to gases, which promotes blistering of the polyethylene material. Additionally, the interest in the industry for use of inner pressure sheath in corrosive applications with high concentrations of carbon dioxide and/or hydrogen sulphides is increasing. Thus, permeation of gases like methane, carbon dioxide and hydrogen sulphide may in some cases be prohibitive for use of the polyethylene inner liners at high temperatures. Other explored solutions to overcome these drawbacks, such as PVDF and Polyimides/Polyamides, are substantially cost prohibitive.

EP 487 691 describes an inner pressure sheath of crosslinked polyethylene to overcome some of the disadvantages of conventional polyethylene. An inner liner with such crosslinked material has shown to be improved compared to inner liners of the similar non-crosslinked (thermoplastic) material. The process of producing an inner liner is carried out in two steps: first the material in non-crosslinked form is manufactured by extrusion, and afterwards the material is crosslinked. For example, a crosslinking step involves a pipeline that is first manufactured by extrusion of the inner layer of polyethylene, followed by metal armoring and outer sheathing. By this process, it is necessary to manufacture the entire pipe before making the actual crosslinking of the inner liner. If there is a quality problem of the inner liner, it is impractical to make the entire pipe without assuring final properties of the crosslinked inner liner. WO03/078134 describes a flexible pipe for transporting hydrocarbons comprising a pressure sheath comprising a crosslinked polyethylene by peroxide/electromagnetic radiation treatment. WO 2004/065092 describes a flexible pipe incorporating a pressure sheath comprising a crosslinked polyethylene sheath by electron beam irradiation.

Despite such proposed approaches for overcoming challenges with material choices for pressure sheath, a completely polyethylene based material will be subject to blistering. Under conditions of use, polymeric materials employed as a pressure sheath are exposed to hydrocarbon fluids and acid gases at high partial pressures. Under these conditions, polymers can absorb these gases, such as CO₂ and H₂S, contained in the hydrocarbon fluid depending on the chemical nature/solubility coefficient of the polymer and on the partial pressure of the gases. When the overall pressure is reduced rapidly or rapid decompression occurs, the dissolved gases would desorb from the polymer sheath suddenly which can lead to irreversible damage in the form of blisters or cracks or microporosity. Such blistering of pressure sheath polymers can be catastrophic causing loss of functionality such as the barrier to hydrocarbon fluids. In addition to the solubility, the permeability coefficient which is the product of diffusion coefficient and solubility is also important for the pressure sheath layer. The pressurized acid gases tend to diffuse through the pressure sheath layer to the external layers such as the tensile armor layers. In contact with moisture the acid gases can exacerbate the corrosion of the tensile armor layers. Thus it is expected that in addition to low solubility of acid gases the pressure sheath layer also has extremely low overall permeability coefficients. In addition, the properties for the pipe's other polymer layers, intermediate layer(s) and outer layer are similar to the desired properties of the inner liner.

Polyolefinic thermoplastics such as polyethylene can undergo significant blistering, in contact with hydrocarbon fluids including acid gases and methane (CH₄) which diffuses through the inner sheath, under high pressure (typically on the order of 200 bars) at a temperature of 60° C. when uncrosslinked and at 90° C. when crosslinked. In addition to permeability properties, the pressure sheath layers needs to possess excellent ductility/flexibility. Crosslinked polyethylene typically possess lower flexibility when compared to an uncrosslinked HDPE. Typically for the application polymers need to possess a tensile modulus that is at least less than 900 MPa and more preferably less than 800 MPa. Conventional crosslinked polyethylene suffers drawback of poor ductility with tensile modulus over 1000 MPa.

On the other hand, compared to polyethylene (crosslinked or uncrosslinked) polymers such as polyamide 11 (PA11), possess better resistance to blistering and swelling under similar conditions. However, polyamide suffers from the significant drawback of rapid hydrolysis when subjected to high pH and temperatures. In addition, the PA11 needs to be compounded with plasticizers, such as n-butyl-benzene-sulfonamide (BBSA), to provide sufficient flexibility for this application that can substantially increase its cost over polyolefin based polymers. Moreover, the incorporation of plasticizers can also substantially increase the solubility and diffusion coefficient of acid gases (particularly CO₂ and H₂S) which can in turn negatively impact the blistering resistance of PAH. Finally, PVDF (with different levels of plasticizers), has typically excellent chemical inertness. However, PVDF has the major drawback of being extremely expensive, with a cost that is significantly higher than that of polyethylene or polyamide. Thus, in order to guarantee excellent lifetime of pressure sheath polymers for up to at least 20 years at pressures of 200 bars, novel cost-effective solution is desired that can overcome the deficiencies of polyethylene.

One class of materials known as thermoplastic elastomers or “TPEs” have found limited application in flexible pipe inner sheath. Such TPEs are usually based on polymers which simultaneously have a) high crystallinity greater than 20% and/or amorphous phase whose glass transition temperature is below room temperature, and b) an elastomeric phase that imparts substantially improved ductility. The elastomeric phase and/or the amorphous region of the thermoplastic polymer can be crosslinked either via chemical or physical crosslinking.

Another class of the thermoplastic elastomers is provided by what are known as “TPVs”. These are thermoplastic vulcanizates which comprise mixtures composed of a) crystalline and/or amorphous polymers whose glass transition temperature is above room temperature and b) amorphous polymers whose glass transition temperature is below room temperature, the amorphous polymers b) having been chemically crosslinked, and this mixture being present with co-continuous phase morphology or having the solid phase as continuous phase.

There is a major requirement for TPE or TPVs which combine high-temperature resistance with oil resistance and barrier properties to be useful in pressure sheath application. Conventional TPE or TPV products mainly combine thermoplastic vulcanizates based on polyamides or polyesters or polypropylene as thermoplastic phase. In these TPVs, there is chemical crosslinking of the elastomeric phase, for example via resins, peroxides, sulfur, diamines or epoxides. There is a need for crosslinkable TPEs or TPVs compositions that can combine the excellent flexibility, barrier and with benefits of crosslinking.

Thus there is a need for alternative and more robust materials that can be used in flexible pipes. There is further a need for alternative and more robust methods for producing materials used in flexible pipes and a need for producing flexible pipes using such materials.

References for citing in an Information Disclosure Statement (37 CFR 1.97(h)) include: U.S. Pat. Nos. 7,829,009; 5,918,641; 5,741,858; 4,299,931; 5,910,543; 6,020,431; 6,207,752; U.S. Patent Pub. Nos. 2004/0219317 A1; 2018/0162978; 2011/0275764; 2009/0203846; WO2013128097; SPE-15814-PA; OTC-5745-MS

### SUMMARY

Embodiments of the present disclosure generally relate to crosslinked elastomer-polymer blends, flexible pipes containing crosslinked elastomer-polymer blends, and methods for forming crosslinked elastomer polymer blends and flexible pipes.

In an embodiment, a flexible pipe includes a plurality of layers, where at least one layer includes a composition including: at least one polar elastomer, and a polymer having a crystallinity of about 20% or greater.

In an embodiment, a process for the production of a flexible unbonded offshore pipe includes shaping a TPE or TPV composition by extruding the composition in an extrusion station and crosslinking the extruded composition, the composition including at least one polar elastomer, a polymer having a crystallinity of about 20% or greater, and a crosslinking agent. The crosslinking agent has an activation temperature substantially above the temperature of the composition during the extrusion thereof. The process includes cross-linking the extruded composition with infrared radiation.

In an embodiment, a pipe includes an inner sheath, an outer sheath, a first armor layer, and a second armor layer, where at least one of the inner sheath and the outer sheath comprises a crosslinked TPE or TPV composition that is the reaction product of an elastomer having a polarity of about 90° or less, a polymer having a crystallinity of about 20% or greater, and a crosslinking agent.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, for the disclosure may admit to other equally effective embodiments.

FIG. 1 is an exploded perspective view of a flexible pipe according to some embodiments.

FIG. 2 is an exploded perspective view of an unbonded flexible pipe, according to at least one embodiment.

### DETAILED DESCRIPTION

One or more embodiments of the present disclosure are directed toward crosslinkable thermoplastic vulcanizate or thermoplastic olefin compositions that are useful for the fabrication of flexible pipes useful for hydrocarbon transportation.

The term “thermoplastic vulcanizate composition” (also referred to as simply thermoplastic vulcanizate or TPV) is broadly defined as any material that includes a dispersed, at least partially vulcanized, rubber component; a thermoplastic component; and an additive oil. A TPV material may further include other ingredients, other additives, or both.

The term “vulcanizate” means a composition that includes some component (e.g., rubber component) that has been vulcanized. The term “vulcanized” refers in general to the state of a composition after all or a portion of the composition (e.g., crosslinkable rubber) has been subjected to some degree or amount of vulcanization. Accordingly, the term encompasses both partial and total vulcanization. A preferred type of vulcanization is “dynamic vulcanization,” discussed below, which also produces a “vulcanizate.” Also, in at least one embodiment, the term vulcanized refers to more than insubstantial vulcanization, e.g., curing (crosslinking) that results in a measurable change in pertinent properties, e.g., a change in the melt flow index (MFI) of the composition by 10% or more (according to any ASTM-1238 procedure). In at least that context, the term vulcanization encompasses any suitable form of curing (crosslinking), both thermal and chemical that can be utilized in dynamic vulcanization.

The term “dynamic vulcanization” means vulcanization or curing of a curable rubber blended with a thermoplastic resin under conditions of shear at temperatures sufficient to plasticize the mixture. In at least one embodiment, the rubber is simultaneously crosslinked and dispersed as micro-sized particles within the thermoplastic component. Depending on the degree of cure, the rubber to thermoplastic component ratio, compatibility of rubber and thermoplastic component, the kneader/mixer/extruder type and the intensity of mixing (shear rate/shear stress), other morphologies, such as co-continuous rubber phases in the plastic matrix, are possible.

The term “partially vulcanized” rubber means more than 5 weight percent (wt %) of the crosslinkable rubber is extractable in boiling xylene, subsequent to vulcanization (preferably dynamic vulcanization), e.g., crosslinking of the rubber phase of the thermoplastic vulcanizate. For example, less than 10 wt %, or less than 20 wt %, or less than 30 wt %, or less than 50 wt % of the crosslinkable rubber may be extractable from the specimen of the thermoplastic vulcanizate in boiling xylene. The percentage of extractable rubber can be determined by the technique set forth in U.S. Pat. No. 4,311,628, and the portions of that patent referring to that technique are incorporated herein by reference for U.S. patent practice.

The term “fully vulcanized” (or fully cured or fully crosslinked) rubber means 5 weight percent (wt %) or less of the crosslinkable rubber is extractable in boiling xylene or cyclohexane, subsequent to vulcanization (such as dynamic vulcanization), e.g., crosslinking of the rubber phase of the thermoplastic vulcanizate. For example, less than 4 wt % or less, or 3 wt % or less, or 2 wt % or less, or 1 wt % or less of the crosslinkable rubber is extractable in boiling xylene or cyclohexane.

The term “flexible pipe” means a flexible pipe or umbilical hose, or a flexible pipe combining the functions of flexible pipes and umbilicals, and can be used in off-shore/subsea or on-shore applications.

The present disclosure relates to crosslinkable thermoplastic vulcanizate (TPV) or thermoplastic olefin (TPE) compositions that include a thermoplastic polyolefin and a rubber having one or more of the following characteristics:

excellent barrier to CO₂ at 80° C. with permeability less than 30 barrers, such as less than 20 barrers, such as less than 10 barrers,
low solubility to CO₂ at 80° C. such as less than 5 cm³ (STP)/cm³·MPa, such as less than 4 cm³ (STP)/cm³·MPa, such as less than 2 cm³ (STP)/cm³·MPa more preferably less than 1 cm³ (STP)/cm³·MPa, as determined by ISO-2782-1, (STP is defined as a temperature of 273.15 K (0° C., 32° F.) and an absolute pressure of exactly 105 Pa (100 kPa, 1 bar)
a resistance of up to 20 cycles to blistering at 90° C., 10000 psi using a 90:10 mol % CH₄:CO₂ or 90:10 mol % CO₂:CH₄ and a depressurization rate of 70 bars/min,
a percent tensile elongation at break (23° C.) when exposed to Diesel Oil at 90° C. for 4 weeks of about 200% or greater, such as about 150% or greater, such as about 100% or greater,
a percent retention of tensile strength at yield (23° C.) when exposed to Diesel Oil at 90° C. for 4 weeks of greater than 50%, greater than 70%, such as greater than 90%, for example 100%,
a percent weight gain change when exposed to Diesel Oil at 90° C. for 4 weeks less than 30%, less than 25%, less than 20%, such as for example 15%,
a percent tensile elongation at break (23° C.) when exposed to aqueous solution of 18% calcium chloride and 14% calcium bromide at 90° C. for 4 weeks of about 200% or greater, such as about 150% or greater, such as about 100% or greater,
a percent retention of tensile strength at yield (23° C.) when exposed to aqueous solution of 18% calcium chloride and 14% calcium bromide at 90° C. for 4 weeks of greater than 50%, greater than 70%, such as greater than 90%, for example 100%,
a percent weight gain change when exposed to aqueous solution of 18% calcium chloride and 14% calcium bromide at 90° C. for 4 weeks less than 30%, less than 25%, less than 20%, such as for example 15%,
a percent tensile elongation at break (23° C.) when exposed to sea water at 90° C. for 4 weeks of about 200% or greater, such as about 150% or greater, such as about 100% or greater,
a percent retention of tensile strength at yield (23° C.) when exposed to sea water at 90° C. for 4 weeks of greater than 50%, greater than 70%, such as greater than 90%, for example 100%,
a percent weight gain change when exposed to sea water at 90° C. for 4 weeks less than 30%, less than 25%, less than 20%, such as for example 15%,
a percent tensile elongation at break (23° C.) when exposed to methanol at 90° C. for 4 weeks of about 200% or greater, such as about 150% or greater, such as about 100% or greater,
a percent retention of tensile strength at yield (23° C.) when exposed to methanol at 90° C. for 4 weeks of greater than 50%, greater than 70%, such as greater than 90%, for example 100%,
a percent weight gain change when exposed to methanol at 90° C. for 4 weeks less than 30%, less than 25%, less than 20%, such as for example 15%,
a percent tensile elongation at break (23° C.) when exposed to IRM 903 at 90° C. for 4 weeks of about 200% or greater, such as about 150% or greater, such as about 100% or greater,
a percent retention of tensile strength at yield (23° C.) when exposed to IRM 903 at 90° C. for 4 weeks of greater than 50%, greater than 70%, such as greater than 90%, for example 100%,
a percent weight gain change when exposed to IRM 903 at 90° C. for 4 weeks less than 30%, less than 25%, less than 20%, such as for example 15%, and
tensile yield strength at 23° C. greater than 15 MPa, preferably greater than 20 MPa, excellent ductility properties such as tensile strain greater than 10%, greater than 15%, tensile modulus less than 1100 MPa.

The crosslinkable thermoplastic elastomers include an uncured rubber phase and a thermoplastic phase. These compositions can be prepared by melt blending of a rubber in the presence of a thermoplastic polymer. In one or more embodiments, s thermoplastic olefin further comprises a compatibilizer.

In the above characteristics, tensile modulus, tensile yield strength, and elongation to break is measured according to ASTM D638 or ISO 37.

In another embodiment, the crosslinked TPE or TPV compositions in flexible pipe pressure sheaths of the present disclosure demonstrate excellent heat resistance and excellent solvent resistance and/or may provide a superior barrier to acid gases and/or maintain excellent ductility over incumbent solutions.

Embodiments of the present disclosure generally relate to crosslinkable thermoplastic elastomers or thermoplastic vulcanizates, flexible pipes containing thermoplastic elastomers or thermoplastic vulcanizates, and methods for forming crosslinked thermoplastic elastomers or thermoplastic vulcanizates and flexible pipes. As used herein, a “TPE” or “TPV” may also be referred to as a “polymer material” or “composition” or “blend”. TPEs and TPVs of the present disclosure may include components of the TPE or TPV, respectively, and/or one or more reaction products of two or more of the components of the TPE or TPV.

Elastomers of the TPE or TPV compositions of the present disclosure are chosen to provide low solubility to gases such as CO₂ and CH₄ to reduce blistering and gas adsorption. Specific elastomers with substantial polarity can provide reduced blistering and gas absorption, as compared to non-polar elastomers, when present in a polymer blend layer of a flexible pipe. Without being bound by theory, it is believed that polar elastomers provide reduced blistering and gas absorption because they are less miscible with hydrocarbons and gases such as CH₄, as compared to non-polar elastomers. The use of polar elastomers in these TPE or TPV compositions substantially enhances the oil resistance of these compositions. Other exemplary elastomers based on fluorinated monomers referred to as fluoroelastomers are also useful in some of the embodiments for producing a low permeability, high chemical resistant TPE or TPV composition. Polar elastomers also provide thermoplastic properties to the elastomer-polymer blends which provide extrudability for flexible pipe manufacturing.

Polymers of the present disclosure are crystalline polymers which can provide an improved barrier to gases and chemical resistance, as compared to non-crystalline polymers. Hydrocarbons, such as CH₄ and acid gases like CO₂ are soluble in amorphous regions compared to crystalline domains that are impermeable. In some embodiments, the amorphous domains of the crystalline polymers are further crosslinked to reduce the gas solubility and thereby enhancing the blistering resistance. Crystalline polymers can further provide thermoset properties when present in a polymer blend layer of a flexible pipe, particularly after a crosslinking stage of the manufacturing process. Crystalline polymers of the present disclosure can have a crystallinity of about 20% or greater (before crosslinking), greater than 30%, preferably greater than 40%, and more preferably greater than 50%. It has been discovered that a crystalline polymer having a crystallinity of about 20% or greater provides sufficient amorphous fractions to improve the ductility of the thermoplastic polymer while being able to be crosslinked to enhance blistering resistance. It has been discovered that crystalline thermoplastic resins with crystallinity greater than 20% when blended with cured or uncured elastomers such as in a TPE or TPV provide a good balance of blistering resistance and tensile yield strength to be suitable for this application. Additionally, specific TPE or TPV compositions of the present invention provide substantially better ductility when compared to prior art solutions incorporating crosslinked polyethylene. Additionally, the use of TPV incorporating crosslinked elastomers dispersed in a thermoplastic resin can help to reduce the amount of crosslinking agent that can result in lower material costs for manufacturing in addition to improved thermoplastic and thermoset properties of elastomer-polymer blends of the present disclosure.

In some embodiments, it has further been found that the crosslinkable TPE or TPV can be formed as thick layers greater than 2 mm, more preferably greater than 4 mm even before crosslinking, without deformation due to gravity forces of the melted and extruded layer even when the layer has a large thickness and thereby a high weight. This is particularly true in the case of TPV with pre-crosslinked elastomeric phase dispersed in a thermoplastic matrix. For example, the thickness of such offshore flexible pipe polymer layers may be about 4 mm or more, such as 6 mm or more, such as 8 mm or more, such as 10 mm or more, such as 12 mm or more, such as 14 mm or more, such as 16 mm or more, such as 18 mm or more.

As used herein “phr” means parts per hundred parts of rubber. Thus, for example, a TPV that comprises 10 phr of an additive, contains 10 parts by weight of the additive per 100 parts by weight of the rubber in the TPV.

The TPE or TPV comprises an elastomer component with low permeability and/or substantial resistance to hydrocarbon fluids, such as those with substantial polarity, a crystalline polymer, and optionally an amount of crosslinking agent. In some embodiments, the TPE or TPV is blended with a crosslinking agent, such as a peroxide, having an activation temperature substantially above, such as at least 5° C. above, such as at least 10° C. above, the temperature of extrusion of the TPE or TPV blend during the extrusion thereof. The term “substantially above the temperature of the elastomer-polymer blend during the extrusion thereof” means that the crosslinking agent should not be activated during the extrusion.

The crosslinking agent can have an activation temperature above the temperature of the TPE or TPV blend during extrusion to avoid activation of the crosslinking agent which would otherwise induce crosslinking during extrusion. During extrusion, crosslinking of the elastomer-polymer blend may result in clogging of the equipment. In one embodiment, the extrusion and the crosslinking are performed in an in-line process, including passing the extruded TPE or TPV blend directly through a crosslinking zone and activating the crosslinking agent to obtain crosslinking. Thus, crosslinking can be carried out in a separate stage subsequent to the extrusion stage.

In one embodiment, the polymer layer is passed from the extruder to the crosslinking zone with less than 25° C. average intermediate cooling, such as less than 10° C. average intermediate cooling, such as substantially no intermediate cooling. The term “average cooling” means average temperature decrease through the thickness of the polymer layer. Thus, the surface of the polymer layer may be cooled down more than the middle of the material. In one embodiment, the cooling of the surface of the polymer layer does not exceed 40° C., such as the cooling of the surface of the polymer layer does not exceed 20° C. from the extruding zone to the crosslinking zone.

### Thermoplastic Elastomer/Thermoplastic Vulcanizate Compositions

### Crystalline Polymers

The TPE or TPV, which is shaped during the process, comprises one or more crystalline polymers. For some purposes, mixtures of crystalline polymers with different or varying properties may be used, e.g. mixtures of two or more crystalline polyethylenes with different densities. By selecting crystalline polymers and one or more suitable elastomer with substantial resistance to hydrocarbon fluids and/or low permeability to acid gases, the present disclosure provides blends having thermoplastic properties for extrusion and excellent thermoset properties after post-extrusion crosslinking, in addition to chemical resistance, reduced blistering, etc.

Crosslinked TPE or TPV of the present disclosure can include crystalline polymer(s) in an amount of from about 20 wt % to about 95 wt %, such as about 30 wt % to about 90 wt %, such as from about 60 wt % to about 85 wt %, for example about 80 wt %, based on the total weight of crystalline polymer(s)+polar elastomer(s).

A crystalline polymer can be a polymer having a crystallinity of about 20% or greater, such as about 40% or greater, such as about 60% or greater, such as about 80% or greater, such as about 90% or greater, such as about 95% or greater, as determined by differential scanning calorimetry (DSC) measured at a heating rate of 10° C./min under a nitrogen atmosphere after removal of thermal history associated with processing. As used herein, the crystallinity of a crystalline polymer is the crystallinity of the crystalline polymer before a crosslinking stage has occurred (either during extrusion or post-extrusion).

In at least one embodiment, a crystalline polymer has a crystallinity of about 20% or greater and is selected from one or more of a polyethylene, a polypropylene, a silane-grafted polyethylene, a polyester, a nylon, a fluorothermoplastic polymer, and a polyketone. For example, in at least one embodiment, a crystalline polymer has a crystallinity of about 40% or greater and is selected from one or more of a polypropylene, a polyester, a fluorothermoplastic polymer, and a polyketone. In at least one embodiment, a crystalline polymer has a crystallinity of about 40% or greater and is a polyethylene. In at least one embodiment, a crystalline polymer has a crystallinity of about 40% or greater and is a polypropylene.

a. Polypropylene

Polypropylenes (also referred to as “propylene-based polymers”) include those solid, generally high-molecular weight plastic resins that primarily comprise units deriving from the polymerization of propylene. In some embodiments, at least 75%, in other embodiments at least 90%, in other embodiments at least 95%, and in other embodiments at least 97% of the units of the propylene-based polymer derive from the polymerization of propylene. In particular embodiments, these polymers include homopolymers of propylene. Homopolymer polypropylene can comprise linear chains and/or chains with long chain branching.

In some embodiments, the propylene-based polymers may also include units deriving from the polymerization of ethylene and/or α-olefins such as 1-butene, 1-hexene, 1-octene, 2-methyl-1-propene, 3-methyl-1-pentene, 4-methyl-1-pentene, 5-methyl-1-hexene, and mixtures thereof. Specifically included are the reactor, impact, and random copolymers of propylene with ethylene or the higher α-olefins, described above, or with C₁₀-C₂₀ olefins.

In some embodiments, the propylene-based polymer includes one or more of the following characteristics:

1) A heat of fusion (Hf) that is about 52.3 J/g or more (such as about 100 J/g or more, such as about 125 J/g or more, such as about 140 J/g or more).

2) A weight average molecular weight (Mw) that is between about 50,000 g/mol and about 2,000,000 g/mol (such as between about 100,000 g/mol and about 1,000,000 g/mol, such as between about 100,000 g/mol and about 600,000 g/mol or between about 400,000 g/mol and about 800,000 g/mol) as measured by gel permeation chromatography (GPC) with polystyrene standards.

3) A number average molecular weight (Mn) that is between about 25,000 g/mol and about 1,000,000 g/mol (such as between about 50,000 g/mol and about 300,000 g/mol) as measured by GPC with polystyrene standards.

4) A g′ᵥᵢₛ that is 1 or less (such as 0.9 or less, such as 0.8 or less, such as 0.6 or less, such as 0.5 or less).

5) A melt mass flow rate (MFR) (ASTM D1238, 2.16 kg weight @ 230° C.) that is about 0.1 g/10 min or more (such as about 0.2 g/10 min or more, such as about 0.2 g/10 min or more). Alternately, the MFR is between about 0.1 g/10 min and about 50 g/10 min, such as between about 0.5 g/10 min and about 5 g/10 min, such as between about 0.5 g/10 min and about 3 g/10 min.

6) A melt temperature (Tₘ) that is from about 110° C. to about 170° C. (such as from about 140° C. to about 168° C., such as from about 160° C. to about 165° C.), as determined by ISO 11357-1,2,3.

7) A glass transition temperature (T_{g}) that is from about −50° C. to about 10° C. (such as from about −30° C. to about 5° C., such as from about −20° C. to about 2° C.), as determined by ISO 11357-1,2,3.

8) A crystallization temperature (T_{c}) that is about 75° C. or more (such as about 95° C. or more, such as about 100° C. or more, such as about 105° C. or more (such as between about 105° C. and about 130° C.), as determined by ISO 11357-1,2,3.

In some embodiments, the propylene-based polymers include a homopolymer of a high-crystallinity isotactic or syndiotactic polypropylene. This polypropylene can have a density of from about 0.89 g/cc³ to about 0.91 g/cc³, with the largely isotactic polypropylene having a density of from about 0.90 g/cc³ to about 0.91 g/cc³. Also, high and ultra-high molecular weight polypropylene that has a fractional melt flow rate can be employed. In some embodiments, polypropylene resins may be characterized by a MFR (ASTM D-1238; 2.16 kg @ 230° C.) that is about 10 dg/min or less (such as about 1.0 dg/min or less, such as about 0.5 dg/min or less).

In some embodiments, the polypropylene includes a homopolymer, random copolymer, or impact copolymer polypropylene or combination thereof. In some preferred embodiments, the polypropylene is a high melt strength (HMS) long chain branched (LCB) homopolymer polypropylene.

The propylene-based polymers may be synthesized by using an appropriate polymerization technique known in the art such as the conventional Ziegler-Natta type polymerizations, and catalysis employing single-site organometallic catalysts including metallocene catalysts.

Examples of polypropylene useful for the TPV compositions described herein include ExxonMobil™ PP5341 (available from ExxonMobil); Achieve™ PP6282NE1 (available from ExxonMobil) and/or polypropylene resins with broad molecular weight distribution as described in U.S. Pat. Nos. 9,453,093 and 9,464,178; and other polypropylene resins described in US20180016414 and US20180051160; Waymax MFX6 (available from Japan Polypropylene Corp.); Borealis Daploy™ WB140 (available from Borealis AG); and Braskem Ampleo 1025MA and Braskem Ampleo 1020GA (available from Braskem Ampleo).

b. Polyethylene

Polyethylenes (also referred to as ethylene-based polymers) include those solid, generally high-molecular weight plastic resins that primarily comprise units deriving from the polymerization of ethylene. In some embodiments, at least 90%, in other embodiments at least 95%, and in other embodiments at least 99% of the units of the ethylene-based polymer derive from the polymerization of ethylene. In particular embodiments, these polymers include homopolymers of ethylene.

In some embodiments, the ethylene-based polymers may also include units deriving from the polymerization of α-olefins such as propylene, 1-butene, 1-hexene, 1-octene, 2-methyl-1-propene, 3-methyl-1-pentene, 4-methyl-1-pentene, 5-methyl-1-hexene, and mixtures thereof.

In some embodiments, the ethylene-based polymer includes one or more of the following characteristics:

1) A melt index (MI) (ASTM D-1238, 2.16 kg@190° C.) that is from about 0.1 dg/min to about 1,000 dg/min (such as from about 1.0 dg/min to about 200 dg/min, such as from about 7.0 dg/min to about 20.0 dg/min).

2) A melt temperature (Tₘ) that is from about 140° C. to about 90° C. (such as from about 135° C. to about 125° C., such as from about 130° C. to about 120° C.).

The ethylene-based polymers may be synthesized by using an appropriate polymerization technique known in the art such as the conventional Ziegler-Natta type polymerizations, and catalysis employing single-site organometallic catalysts including metallocene catalysts. Ethylene-based polymers are commercially available. For example, polyethylene is commercially available under the tradename ExxonMobil™ Polyethylene (ExxonMobil). Ethylene-based copolymers are commercially available under the tradename ExxonMobil™ Polyethylene (ExxonMobil), which include metallocene produced linear low density polyethylene including Exceed™, Enable™, and Exceed™ XP.

In some embodiments, the PE may be any crystalline PE, such as a high density PE (“HDPE”) which has a density of about 0.940 g/cc to about 0.965 g/cc and a MI in the range from 0.1 to 20. HDPE is commercially available in different forms, and may have a polydispersity index (Mw/Mn) in the range from about 5 to about 40. In some embodiments, the PE is a bimodal high density PE such as ExxonMobil HD 7800P which is a high-density polyethylene having a melt flow index of 0.25 g/10 min. ExxonMobil HD 7800P available from ExxonMobil of Houston, Tex.

In some embodiments, the polyethylene is what is known as a “polyethylene-raised temperature”. For example, polyethylenes having increased thermal resistance (“polyethylene raised temperature” or “polyethylene of raised temperature” or “polyethylene of raised temperature resistance” or PE-RT) are defined in the revised ASTM F2769-10 standards in 2010, ASTM F2623 revised 2008 or ISO 1043-1 standards revised in 2011, ISO 24033 and revised in 2009 ISO 22391 and revised in 2009 by the ISO 15494 standard revised in 2003 applications.

Crosslinked PE-RT can be obtained by crosslinking at least one PE-RT type I or type II, and the crosslinked PE-RT can be used in the layer of the pipe, those obtained by crosslinking PE-RT type II (higher density) may be preferred because they typically are more resistant to high pressures and/or temperatures.

Non-crosslinked PE-RT are high density polyethylene (HDPE) obtained by the polymerization of ethylene and one or more α-olefins having at least three carbon atoms, and such as from 4 to 10 carbon atoms, such as from 6 to 8 carbon atoms in the presence of a suitable catalyst. Thus, co-monomers polymerized in the presence of ethylene are propylene, 1-butene, isobutylene, 4-methyl-1-pentene, 1-hexene, 1-octene, 1-decene. The layer of the flexible pipe of the present disclosure typically comprises a TPV composition with a PE-RT as the thermoplastic polymer obtained by polymerizing ethylene and an α-olefin selected from 1-butene, 1-hexene and 1-octene, especially 1-hexene and 1-octene, preferably 1-hexene. Such PE-RT therefore can have side chains of ethyl, n-butyl or n-hexyl, such as n-butyl or n-hexyl. Methods of making non-crosslinked PE-RT using specific catalysts are well known in the art and are described for example in patents EP 0416815, WO 94/03509, and EP 0 100 879.

Certain bimodal polyethylene can also belong to the category of PE-RT Type II. 1. A bimodal polyethylene, comprising: a density of from 0.930 to 0.965 gram/cubic centimeters (g/ccm); a melt index (I₂) of from 0.1 to 1.0 gram/10 minute; a melt flow ratio (121/12) of from 20 to 90; wherein the bimodal polyethylene includes a high weight average molecular weight (HMW) polyethylene component and a low weight average molecular weight (LMW) polyethylene component characterized in which a chromatogram of a gel permeation chromatography (GPC) of the bimodal polyethylene displays a resolved bimodal weight average molecular weight distribution with a local minimum in a range of log (molecular weight) 3.5 to 5.5 between a peak representing the HMW polyethylene component and a peak representing the LMW polyethylene component.

A polyethylene resin having a multimodal molecular weight distribution can have (a) a density in the range from 0.925 g/ccm to 0.965 g/ccm, and (b) a melt index (I₂) from 0.1 g/10 min to 5 g/10 min, and (c) comprise a high molecular weight (HMW) component and a low molecular weight (LMW) component, and wherein the HMW component comprises at least one high molecular weight ethylene interpolymer having a density in the range from 0.910 g/ccm to 0.935 g/ccm, and a melt index of 1.0 g/10 min or lower, and wherein the LMW component comprises at least one low molecular weight ethylene polymer having a density in the range from 0.945 g/ccm to 0.965 g/ccm, and a melt index in the range from 2.0 g/10 min to less than 200 g/10 min, and wherein the at least one high molecular weight interpolymer and/or the at least one low molecular weight polymer is a homogeneous, substantially linear interpolymer.

The use of a specific catalyst can provide unique molecular structures (controlled distribution of comonomer) and crystallinity that can provide superior performance such as hydrostatic pressure resistance at elevated temperatures making it useful for pressure sheath applications. For example, the PE-RT can be used in pipes to transport hot and cold water under pressure, both for domestic and industrial applications.

Exemplary PE-RT resins useful in pressure sheath layer(s) according to the invention have a density (ASTM D 1505 revised in 2010 or ISO 1183 revised in 2012) of from about 0.930 g/cm³ to about 0.965 g/cm³, such as from about 0.935 g/cm³ to about 0.960 g/cm³ such as from about 0.940 g/cm³ to about 0.955 g/cm³, a melt index (according to ASTM D1238 or ISO 2010 revised in 1133 revised in 2011) measured at 190° C. under a weight of 2.16 kg of from about 0.1 g/10 minutes to about 15 g/10 minutes, such as from about 0.1 g/10 min to about 5 g/10 minutes, such as from about 0.1 g/10 minutes to about 1.5 g/10 minutes, a tensile yield strength (according to ASTM D638 revised 2010 or ISO 527-2 revised in 2012) of from about 15 MPa to about 35 MPa, such as from about 20 MPa to about 30 MPa, such as from about 25 MPa to about 30 MPa, and an elongation at break (according to ASTM D638 revised 2010 or ISO 527-2 revised in 2012), at least greater than about 50%, such as greater than about 300% such as greater than or equal to about 500%.

Exemplary examples of PE-RT Type I and II resins useful in some embodiments of the present disclosure include Dowlex™ 2377, Dowlex™ 2388, and Hypertherm™ 2399 (available from Dow Chemical Company using Unipol II process technology), Xsene XRT-70 (available from Total Petrochemicals & Refining S.A. using a double loop technology), Marlex HP076, HHM4903 (from Chevron Philips), HD6704 (from ExxonMobil), Hostalen 4731B (from LyondellBasell Industries, Rotterdam, The Netherlands), and Eltex-TUB220-RT (from Ineos).

In some embodiments, the polyethylene includes a low density, linear low density, or high density polyethylene. In some embodiments, the polyethylene can be a high melt strength (HMS) long chain branched (LCB) homopolymer polyethylene.

c. Fluorothermoplastic Polymers

A crystalline polymer may be a fluorothermoplastic polymer. The acronyms listed in Table 1 are used herein to describe monomers from which a fluoropolymer hereof can be obtained, in the case of either a fluoroelastomer or a fluorothermoplastic hereof.

TABLE 1
Acronyms

| Acronym | Meaning |
|---|---|
| CTFE | Chlorotrifluoroethylene |
| CPFP | Chloropentafluoropropylene |
| CSM | Cure-site monomer |
| E | Ethylene (i.e. ethene), when not combined in a |
| | larger acronym |
| P | Propylene (i.e. propene), when not combined in a |
| | larger acronym |
| E/P | Ethylene/propylene: ethylene or propylene or both |
| | monomers |
| HFP | Hexafluoropropylene |
| PAAE | Perfluoro(alkyl allyl ether) |
| PAVE | Perfluoro(alkyl vinyl ether) |
| PAV/AE | Perfluoro(alkyl vinyl/allyl ether), i.e. PAVE or PAAE |
| | or both monomers |
| TFE | Tetrafluoroethylene |
| VDF | Vinylidene fluoride |

In various embodiments, useful alkyl groups can be C1-C6 alkyl groups, and these can include any one or more of: methyl, ethyl, n-propyl, iso-propyl, n-butyl, sec-butyl, iso-butyl, tert-butyl, n-pentyl, iso-pentyl, sec-pentyl, tert-pentyl, neopentyl, n-hexyl, iso-hexyl, sec-hexyl, tert-hexyl, neohexyl, cyclobutyl, cyclopentyl, or cyclohexyl.

As used herein, a perfluoro(alkyl allyl ether) monomer means a perfluoro(alkyl allyl ether) that contains from 4 to 9 carbon atoms. As used herein, a perfluoro(alkyl vinyl ether) monomer means a perfluoro(alkyl vinyl ether) that contains from 3 to 8 carbon atoms.

In perfluoro(alkyl vinyl/allyl ether) monomers (PAV/AE) hereof, the perfluoroalkyl group can be any of the perfluoro(C1-C6 alkyl) or perfluoro(C4-C6 cycloalkyl) groups; in various embodiments, such perfluoroalkyl group(s) can be perfluoro(C1, C2, nC3, nC4, nC5, or nC6 alkyl) group(s), and particularly perfluoro(C1, C2, or nC3 alkyl) group(s). For example, see those monomers described in U.S. Pat. No. 6,255,535 to Moore et al., herein incorporated by reference.

One or more than one PAV/AE monomer can be used to prepare a PAV/AE monomer residue-containing polymer hereof; in some embodiments, this can be a combination of a PAVE monomer and a PAAE monomer, a combination of PAVE monomers, a combination or PAAE monomers, or both. In various embodiments, a combination of PAVE monomers can be used. In some embodiments, a single type of PAVE monomer will be the only PAV/AE monomer used in forming the copolymer. Of PAVE monomers, perfluoro(methyl vinyl ether) and perfluoro(propyl vinyl ether) can be particularly useful.

Many polymers useful herein are copolymers, e.g., dipolymers, tripolymers, or tetrapolymers (aside from cure-site-monomer content, if any). The format of the copolymers can be any useful format known in the art. For example, copolymers having random, statistical, alternating, or block copolymer chains can be used; and polymer architectures can be, e.g., linear, graft, branched (simple-branched, e.g., having about or less than one branch per thousand main-chain monomer residues), or comb-, brush-, or hyper-branched.

Fluorothermoplastics can exhibit a glass transition temperature (Tg) below the melting temperature (Tm, e.g., crystalline Tm) thereof, and that at a temperature between its Tg and Tm is semi-crystalline and exhibit plasticity when in a non-crosslinked state. In various embodiments, a fluorothermoplastic can be one that exhibits about or more than 40% crystallinity (below its melting temperature), as measured by differential scanning calorimetry. In some embodiments, the crystallinity can be up to, about, or more than 45, 50, 55, 60, 65, or 70%; in various embodiments, the crystallinity can be about or less than 80, 75, or 70%; or from about 45 to about 70%. Crystallinity can also be determined by X-ray diffraction. In various embodiments, the fluorothermoplastic can have a softening or melting point that is from about 80° C. to about 350° C. In various embodiments, a fluorothermoplastic for use herein can have a Tg that is in the range of about −120° C. to about +20° C., and typically about −95° C. to about −20° C.

Useful fluorothermoplastics can have from about 45 wt % to about 75 wt %, and more typically up to about 72 wt % fluorine content. These can be formed as copolymers of any of TFE, HFP, CTFE, CPFP, and VDF with one another, with PAVE, E, and/or P; thermoplastic PVDF is also useful in some embodiments hereof. Examples of useful fluorothermoplastics include those listed in Table 2. TFE-CTFE thermoplastics with high crystallinity (>40%) can also be used.

TABLE 2
Exemplary
Fluorthermoplastics

| Fluorothermoplastic | | |
|---|---|---|
| (Family/Example) | Abbrev. | Exemplary Commercial Types |
| Poly(TFE-co-HFP) | FEP | DuPont Teflon FEP, AGC (Asahi Glass Co.) Fluon |
| | | FEP, 3M Dyneon FEP |
| Poly(TFE-co-PAVE) | | |
| Poly(TFE-co-PMVE) | MFA | Solvay-Solexis Solef MFA (formerly Hyflon MFA), |
| | | AGC Fluon MFA |
| Poly(TFE-co-PPVE) | PFA | DuPont Teflon PFA, Solvay-Solexis Solef PFA |
| | | (formerly Hyflon PFA), 3M Dyneon PFA |
| Poly(VDF) | PVDF | AtoFina Kynar PVDF, AGC Fluon PVDF, Solvay- |
| | | Solexis Solef PVDF (formerly Hylar) |
| Poly(E/P-co-TFE) | | |
| Poly(E-co-TFE) | ETFE | DuPont Tefzel ETFE, AGC Fluon ETFE, 3M |
| | | Dyneon ETFE |
| Poly(E/P-co-CTFE) | | |
| Poly(E-co-CTFE) | ECTFE | AGC Fluon ECTFE, Solvay-Solexis Solef ECTFE |
| | | (formerly Halar) |
| Poly(TFE-co-HFP-co-VDF) | THV | 3M Dyneon THV-200 |
| Poly(E/P-co-HFP) | | |
| poly(E-co-HFP) | PEHFP | |
| Poly(E/P-co-CPFP) | | |
| poly(E-co-CPFP) | PECPFP | |

In various embodiments, the fluorothermoplastic can be a perfluoropolymer, such as FEP, MFA, PFA, PVDF, or THV, or can contain non-perfluoro monomer residues, such as alkylene residues as in the case of ETFE, ECTFE, PEHFP, or PECPFP, or TFE-CTFE. In either case, a fluorothermoplastic polymer hereof can contain CSM monomer residues or can be CSM-free. In various embodiments, CSM-free fluorothermoplastic polymers can be used herein.

Fluorothermoplastic polymers of the present disclosure can be synthesized using any suitable catalyst under polymerization conditions. Other suitable fluorothermoplastic polymers are described in U.S. Patent Publication No. 2009/0203846, which is incorporated by referenced.

d. Polyester Polymers

Polyesters are condensation polymers. The various polyesters can be either aromatic or aliphatic or combinations thereof and are generally directly or indirectly derived from the reactions of diols such as glycols having a total of from 2 to 6 carbon atoms and from about 2 to about 4 carbon atoms with aliphatic acids having a total of from about 2 to about 20 carbon atoms and from about 3 to about 15 carbon atoms or aromatic acids having a total of from about 8 to about 15 carbon atoms. Aromatic polyesters can be, for example, a polyethyleneterephthalate (PET), a polytrimethyleneterephthalate (PTT), a polybutyleneterephthalate (PBT), a polyethyleneisophthalate, or a polybutylenenapthalate.

The weight averages molecular weight of a polyester can be from about 40,000 to above 110,000, such as about 50,000 to about 100,000.

Suitable thermoplastic polyesters include the various ester polymers such as polyester, copolyester, or polycarbonate, a monofunctional epoxy endcapped derivative thereof, and mixtures thereof. The various polyesters can be either aromatic or aliphatic or combinations thereof and are generally directly or indirectly derived from the reactions of diols such as glycols having a total of from 2 to 6 carbon atoms and desirably from about 2 to about 4 carbon atoms with aliphatic acids having a total of from 2 to 20 carbon atoms and desirably from about 3 to about 15 or aromatic acids having a total of from about 8 to about 15 carbon atoms. Generally, aromatic polyesters can be polyethyleneterephthalate, polybutyleneterephthalate, polyethyleneisophthalate, polybutylenenaphthalate, and the like, as well as endcapped epoxy derivative thereof, e.g., a monofunctional epoxy polybutyleneterephthalate. Various polycarbonates can also be utilized and the same are esters of carbonic acid. A suitable polycarbonate is that based on bisphenol A, i.e., poly(carbonyldioxy-1,4-phenyleneisopropyl-idene-1,4-phenylene).

The various ester polymers also include block polyesters such as those containing at least one block of a polyester and at least one rubbery block such as a polyether derived from glycols having from 2 to 6 carbon atoms, e.g., polyethylene glycol, or from alkylene oxides having from 2 to 6 carbon atoms. An exemplary block polyester is polybutyleneterephthalate-b-polytetramethylene ether glycol which is available as Hytrel® from DuPont. The amount of polyester in the blend is generally from about 25 to about 100, such as from about 30 to about 90, such as from about 35 to about 75 parts by weight per 100 parts by weight of total acrylic rubbers.

Polyesters of the present disclosure can be synthesized using any suitable catalyst under polymerization conditions. Other suitable polyesters are described in U.S. Pat. Nos. 6,020,431 and 6,207,752, which are incorporated by reference herein.

e. Polyamide Polymers

Suitable thermoplastic polyamide resins are crystalline or amorphous high molecular weight solid polymers including homopolymers, copolymers and terpolymers having recurring amide units within the polymer chain. Commercially available nylons having a glass transition temperature (Tg) or melting temperature (Tm) above 100° C., such as those having a Tm from about 160° C. to about 280° C., whether typically used in fiber forming or molding operations. Examples of suitable polyamides are polylactams such as nylon 6, polypropiolactam (nylon 3), polyenantholactam (nylon 7), polycapryllactam (nylon 8), polylaurylactam (nylon 12), and the like; homopolymers of amino acids such as polyaminoundecanoic acid (nylon 11); polypyrrolidinone (nylon 4); copolyamides of a dicarboxylic acid and a diamine such as nylon 6,6; polytetramethyleneadipamide (nylon 4,6); polytetramethyleneoxalamide (nylon 4,2); polyhexamethyleneazelamide (nylon 6,9); polyhexamethylenesebacamide (nylon 6,10); polyhexamethyleneisophthalamide (nylon 6,1); polyhexamethylenedodecanoic acid (nylon 6,12) and the like; aromatic and partially aromatic polyamides; copolyamides such as of caprolactam and hexamethyleneadipamide (nylon 6/6,6), or a terpolyamide, e.g., nylon 6/6,6/6,10; block copolymers such as polyether polyamides; or mixtures thereof. Additional examples of suitable polyamides are described in the Encyclopedia of Polymer Science and Technology, by Kirk & Othmer, Second Edition, Vol. 11, pages 315-476, are incorporated by reference. Exemplary polyamides employed can be nylon 6, nylon 11, nylon 12, nylon 6,6, nylon 6,9, nylon 6,10, and nylon 6/6,6. For example, a polyamide can be selected from nylon 6, nylon 6,6, nylon 11, nylon 12 and mixtures or copolymers thereof. The polyamides generally have a number average molecular weight of from about 10,000 to about 50,000, such as from about 30,000 to about 40,000.

### Elastomers

The TPE or TPV comprises one or more elastomers with substantial resistance to hydrocarbon fluids, and low permeability to gases such as CO₂. Crosslinked TPE or TPV blends of the present disclosure can include elastomer(s) in an amount of from about 2 wt % to about 70 wt %, such as about 5 wt % to about 60 wt %, such as from about 10 wt % to about 40 wt %, such as from about 15 wt % to about 40 wt %, for example about 20 wt %, based on the total weight of crystalline polymer(s)+elastomer(s).

In at least one embodiment, the elastomer is selected from one or more of a polyolefin elastomer, an ethylene alpha olefin diene rubber, a nitrile rubber, a hydrogenated nitrile rubber, an ethylene vinyl acetate, an acrylic acid-ester copolymer rubber, a fluoroelastomeric polymer, a butyl rubber, a polyisobutylene paramethyl styrene copolymer. For example, in at least one embodiment, the elastomer has substantial resistance to hydrocarbon fluids and is selected from the group of nitrile rubber, a hydrogenated nitrile rubber, carboxylated nitrile rubber, an ethylene vinyl acetate, an acrylic acid-ester copolymer rubber, and a fluoroelastomeric polymer. In some embodiments, the elastomer has excellent barrier to gases such as CO₂ and is selected from the group comprising butyl rubber, and nitrile rubber.

In some embodiments of the present disclosure, the elastomers can have a polarity (based on contact angle) of about 90° or less, such as about 80° or less, such as about 60° or less, such as about 50° or less, such as about 40° or less. Contact angle refers the slope of the tri-point at the intersection of observation plane and the drop of liquid water (which is considered polar) disposed on a surface of solid polymer (that is substantially or entirely free of surface contamination) that is disposed on a flat surface perpendicular to gravitational force. A lower contact angle indicates high polarity, whereas a high contact angle indicates low polarity. A suitable contact angle analyzer can be obtained from AST Products, Inc. of Billerica, Mass. using the AutoFAST Algorithm software utilizing the Fox-Zisman Theory.

In at least one embodiment, the elastomer has a polarity (based on contact angle) of about 90° or less and is selected from one or more a nitrile rubber, a hydrogenated nitrile rubber, an ethylene vinyl acetate, an acrylic acid-ester copolymer rubber. For example, in at least one embodiment, a polar elastomer has a polarity (based on contact angle) of about 90° or less and is selected from a nitrile rubber, a hydrogenated nitrile rubber, an ethylene vinyl acetate, and an acrylic acid-ester copolymer rubber.

In some embodiments, the elastomer can be crosslinked to produce a finely dispersed rubber domains in a thermoplastic polymer matrix. For example, in some embodiments, the elastomer is partially or fully (completely) crosslinked before an extrusion stage. It has been discovered that partially curing an elastomer before an extrusion stage, followed by post-extrusion crosslinking, improves the thermoset properties of a crosslinked elastomer-polymer blend while nonetheless maintaining sufficient thermoplastic properties of the blend for extrusion. The degree of crosslinking can be measured by determining the amount of elastomer that is extractable from the crosslinked elastomer product by using cyclohexane or boiling xylene as an extractant. This method is disclosed in U.S. Pat. No. 4,311,628, which is incorporated herein by reference. In some embodiments, the elastomer has a degree of crosslinking where not more than about 5.9 wt %, such as not more than about 5 wt %, such as not more than about 4 wt %, such as not more than about 3 wt % is extractable by cyclohexane at 23° C. as described in U.S. Pat. Nos. 5,100,947 and 5,157,081, which are incorporated herein by reference. In these or other embodiments, the elastomer is crosslinked to an extent where greater than about 94 wt %, such as greater than about 95 wt %, such as greater than about 96 wt %, such as greater than about 97 wt % by weight of the elastomer is insoluble in cyclohexane at 23° C. Alternately, in some embodiments, the elastomer has a degree of cure such that the crosslink density is at least 4×10⁻⁵ moles per milliliter of elastomer, such as at least 7×10⁻⁵ moles per milliliter of elastomer, such as at least 10×10⁻⁵ moles per milliliter of elastomer. See also “Crosslink Densities and Phase Morphologies in Dynamically Vulcanized TPEs,” by Ellul et al., RUBBER CHEMISTRY AND TECHNOLOGY, Vol. 68, pp. 573-584 (1995).

As used herein, a “partially vulcanized” rubber is one wherein more than 5 weight percent (wt %) of the crosslinkable rubber is extractable in boiling xylene, subsequent to vulcanization (preferably dynamic vulcanization), e.g., crosslinking of the rubber phase of the TPV. For example, in a TPV comprising a partially vulcanized rubber at least 5 wt % and less than 20 wt %, or 30 wt %, or 50 wt % of the crosslinkable rubber can be extractable from the specimen of the TPV in boiling xylene.

Despite an elastomer being partially or fully cured in some embodiments, the blends of this disclosure can be processed and reprocessed by conventional plastic processing techniques such as extrusion, injection molding, blow molding, and compression molding.

In one embodiment, the elastomer is in the form of a thermoplastic vulcanizate comprising the elastomer and a thermoplastic polymer (such as a polypropylene of the crystalline polymer section of this disclosure). The elastomer can be in the form of finely-divided and well-dispersed particles of vulcanized or cured elastomer within a continuous thermoplastic phase or matrix. In some embodiments, a co-continuous morphology or a phase inversion can be achieved. In those embodiments where the cured elastomer is in the form of finely-divided and well-dispersed particles within the thermoplastic medium, the elastomer particles can have an average diameter that is about 50 μm or less (such as about 30 μm or less, such as about 10 μm or less, such as about 5 μm or less, such as about 1 μm or less). In some embodiments, at least about 50%, such as about 60%, such as about 75% of the particles have an average diameter of about 5 μm or less, such as about 2 μm or less, such as about 1 μm or less.

a. Ethylene-Alpha Olefin Diene Rubber

The term ethylene-alpha olefin diene rubber refers to rubbery terpolymers polymerized from ethylene, at least one other α-olefin monomer, and at least one diene monomer (for example, an ethylene-propylene-diene terpolymer also referred to as an EPDM terpolymer). The α-olefins may include propylene, 1-butene, 1-hexene, 4-methyl-1-pentene, 1-octene, 1-decene, or combinations thereof. In one embodiment, the α-olefins include propylene, 1-hexene, 1-octene or combinations thereof. The diene monomers may include 5-ethylidene-2-norbornene; 5-vinyl-2-norbornene; divinylbenzene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; or a combination thereof. Polymers prepared from ethylene, α-olefin, and diene monomers may be referred to as a terpolymer or even a tetrapolymer in the event that multiple α-olefins or dienes are used.

In some embodiments, where the diene includes 5-ethylidene-2-norbornene (ENB) or 5-vinyl-2-norbornene (VNB), the ethylene-propylene rubber may include at least about 1 wt % (such as at least about 3 wt %, such as at least about 4 wt %, such as at least about 5 wt %) based on the total weight of the ethylene-propylene rubber. In other embodiments, where the diene includes ENB or VNB, the ethylene-propylene rubber may include from about 1 wt % to about 15 wt % (such as from about 3 wt % to about 15 wt %, such as from about 5 wt % to about 12 wt %, such as from about 7 wt % to about 11 wt %) from 5-ethylidene-2-norbornene based on the total weight of the ethylene-propylene rubber.

In some embodiments, the ethylene-propylene rubber includes one or more of the following characteristics:

1) An ethylene-derived content that is from about 10 wt % to about 99.9 wt %, (such as from about 10 wt % to about 90 wt %, such as from 12 wt % to about 90 wt %, such as from about 15 wt % to about 90 wt % such as from about 20 wt % to about 80 wt %, such as from about 40 wt % to about 70 wt %, such as from about 50 wt % to about 70 wt %, such as from about 55 wt % to about 65 wt %, such as from about 60 wt % and about 65 wt %) based on the total weight of the ethylene-propylene rubber. In some embodiments, the ethylene-derived content is from about 40 wt % to about 85 wt %, such as from about 40 wt % to about 85 wt %, based on the total weight of the ethylene-propylene rubber.

2) A diene-derived content that is from about 0.1 to about to about 15 wt %, such as from about 0.1 wt % to about 5 wt %, such as from about 0.2 wt % to about 10 wt %, such as from about 2 wt % to about 8 wt %, or from about 4 wt % to about 12 wt %, such as from about 4 wt % to about 9 wt %) based on the total weight of the ethylene-propylene rubber. In some embodiments, the diene-derived content is from about 3 wt % to about 15 wt % based on the total weight of the ethylene-propylene rubber.

3) The balance of the ethylene-propylene rubber including α-olefin-derived content (e.g., C₂ to C₄₀, such as C₃ to C₂₀, such as C₃ to C₁₀ olefins, such as propylene).

4) A weight average molecular weight (Mw) that is about 100,000 g/mol or more (such as about 200,000 g/mol or more, such as about 400,000 g/mol or more, such as about 600,000 g/mol or more). In these or other embodiments, the Mw is about 1,200,000 g/mol or less (such as about 1,000,000 g/mol or less, such as about 900,000 g/mol or less, such as about 800,000 g/mol or less). In these or other embodiments, the Mw can be between about 500,000 g/mol and about 3,000,000 g/mol (such as between about 500,000 g/mol and about 2,000,000, such as between about 500,000 g/mol and about 1,500,000 g/mol, such as between about 600,000 g/mol and about 1,200,000 g/mol, such as between about 600,000 g/mol and about 1,000,000 g/mol).

5) A number average molecular weight (Mn) that is about 20,000 g/mol or more (such as about 60,000 g/mol or more, such as about 100,000 g/mol or more, such as about 150,000 g/mol or more). In these or other embodiments, the Mn is less than about 500,000 g/mol (such as about 400,000 g/mol or less, such as about 300,000 g/mol or less, such as about 250,000 g/mol or less).

6) A Z-average molecular weight (Mz) that is between about 10,000 g/mol and about 7,000,000 g/mol (such as between about 50,000 g/mol and about 3,000,000 g/mol, such as between about 70,000 g/mol and about 2,000,000 g/mol, such as between about 75,000 g/mol and about 1,500,000 g/mol, such as between about 80,000 g/mol and about 700,000 g/mol, such as between about 100,000 g/mol and about 500,000 g/mol).

7) A polydispersity index (Mw/Mn; PDI) that is between about 1 and about 10 (such as between about 1 and about 5, such as between about 1 and about 4, such as between about 2 and about 4 or between about 1 and about 3, such as between about 1.8 and about 3 or between about 1 and about 2, or between about 1 and 2.5).

8) A dry Mooney viscosity (ML₍₁₊₄₎ at 125° C.) per ASTM D-1646, that is from about 10 MU to about 500 MU or from about 50 MU to about 450 MU. In these or other embodiments, the Mooney viscosity is 250 MU or more, such as 350 MU or more.

9) A g′ᵥᵢₛ that is 0.8 or more (such as 0.85 or more, such as 0.9 or more, such as 0.95 or more, for example about 0.96, about 0.97, about 0.98, about 0.99, or about 1).

10) An LCB index (at 125° C.), that is about 5.0 or less (such as about 4.0 or less, such as about 3.0 or less, such as about 2.5 or less, such as about 2.0 or less, such as about 1.5 or less), where LCB index is defined based on large amplitude oscillatory shear measurements using a strain of 1000%, and frequency of 0.6 rad/s.

11) A Δδ that is about 10° or more (such as about 20° or more, such as greater than about 30° or more, such as about 32° or more, such as about 35° or more), where Δδ=δ(0.1 rad/s, 125° C.)−δ(128 rad/s, 125° C.).

12) A glass transition temperature (T_{g}), as determined by Differential Scanning calorimetry (DSC) according to ASTM E 1356, that is about −20° C. or less (such as about −30° C. or less, such as about −50° C. or less). In some embodiments, T_{g} is between about −20° C. and about −60° C.

13) A large amplitude oscillatory shear (LAOS) branching index of less than 3.

14) A Δδ of from about 30 degrees to about 80 degrees (such as about 30 degrees to about 50 degrees) from small amplitude oscillatory shear (SAOS).

The ethylene-propylene rubber may be manufactured or synthesized by using a variety of techniques. For example, these terpolymers can be synthesized by employing solution, slurry, or gas phase polymerization techniques of combination thereof that employ various catalyst systems including Ziegler-Natta systems including vanadium catalysts and take place in various phases such as solution, slurry, or gas phase. Exemplary catalysts include single-site catalysts including constrained geometry catalysts involving Group IV-VI metallocenes. In some embodiments, the EPDMs can be produced via a conventional Zeigler-Natta catalyst using a slurry process, especially those including Vanadium compounds, as disclosed in U.S. Pat. No. 5,783,645, as well as metallocene catalysts, which are also disclosed in U.S. Pat. No. 5,756,416. Other catalysts systems such as the Brookhart catalyst system may also be employed. Optionally, such EPDMs can be prepared using the above catalyst systems in a solution process.

Elastomeric terpolymers are commercially available under the trade names Vistalon™ (ExxonMobil Chemical Co.; Houston, Tex.), Keltan™ (Arlanxeo Performance Elastomers; Orange, Tex.), Nordel™ IP (Dow), NORDEL MG™ (Dow), Royalene™ (Lion Elastomers), and Suprene™ (SK Global Chemical). Specific examples include Vistalon 3666, Keltan 5469 Q, Keltan 4969 Q, Keltan 5469 C, and Keltan 4869 C, Royalene 694, Royalene 677, Suprene 512F, Nordel 6555.

In some embodiments, the ethylene-based elastomer may be obtained in an oil extended form, with about a 50 phr to about 200 phr process oil, such as about 75 phr to about 120 phr process oil on the basis of 100 phr of elastomer.

b. Nitrile Rubber

“Nitrile rubber”, “nitrile polymer” or NBR is intended to have a broad meaning and is meant to encompass a copolymer having repeating units derived from at least one conjugated diene, at least one α,β-unsaturated nitrile, and optionally a termonomer selected from the group consisting of conjugated dienes, unsaturated carboxylic acids, alkyl esters of unsaturated carboxylic acids, alkoxyalkyl acrylates and ethylenically unsaturated monomers other than dienes.

The conjugated diene may be any suitable conjugated diene such as a C₄-C₆ conjugated diene. A conjugated diene can be butadiene, isoprene, piperylene, 2,3-dimethyl butadiene and mixtures thereof. For example, C₄-C₆ conjugated dienes can be butadiene, isoprene and mixtures thereof. In at least one embodiment, the C₄-C₆ conjugated diene is butadiene.

The α,β-unsaturated nitrile may be any suitable α,β-unsaturated nitrile, such as a C₃-C₅ alpha,beta-unsaturated nitrile. For example, C₃-C₅ α,β-unsaturated nitriles include acrylonitrile, methacrylonitrile, ethacrylonitrile and mixtures thereof. In at least one embodiment, the C₃-C₅ alpha,beta-unsaturated nitrile is acrylonitrile.

The unsaturated carboxylic acid may be any suitable unsaturated carboxylic acid copolymerizable with the other monomers, such as a C₃-C₁₆ α,β-unsaturated carboxylic acid. An unsaturated carboxylic acid can be an acrylic acid, methacrylic acid, itaconic acid and maleic acid or a mixture thereof.

The alkyl ester of an unsaturated carboxylic acid may be any suitable alkyl ester of an unsaturated carboxylic acid copolymerizable with the other monomers, such as an alkyl ester of an C₃-C₁₆ α,β-unsaturated carboxylic acid. Exemplary alkyl esters of an unsaturated carboxylic acid are alkyl esters of acrylic acid, methacrylic acid, itaconic acid and maleic acid and mixtures thereof, such as butyl acrylate, methyl acrylate, 2-ethylhexyl acrylate and octyl acrylate. Exemplary alkyl esters include methyl, ethyl, propyl, and butyl esters.

The alkoxyalkyl acrylate may be any known alkoxyalkyl acrylate copolymerizable with the other monomers, preferably methoxyethyl acrylate, ethoxyethyl acrylate and methoxyethoxyethyl acrylate and mixtures thereof.

The ethylenically unsaturated monomer may be any suitable ethylenically unsaturated monomer copolymerizable with the other monomers, such as allyl glycidyl ether, vinyl chloroacetate, ethylene, butene-1, isobutylene and mixtures thereof.

The preparation of nitrile rubbers via polymerization of the above referenced monomers is well known to a person skilled in the art and is extensively described in the literature (e.g., Houben-Weyl, Methoden der Organischen Chemie, Vol. 14/1, Georg Thieme Verlag Stuttgart, 1961).

Suitable nitrile rubbers comprise rubbery polymers of 1,3-butadiene or isoprene and acrylonitrile. Exemplary nitrile rubbers include polymers of 1,3-butadiene and between 15-60 weight percent acrylonitrile, preferably between 25 to 50 weight percent acrylonitrile.

In some embodiments, the nitrile rubber includes one or more of the following characteristics:

1) An acrylonitrile-derived content that is about 20 wt % or more (such as from about 20 wt % to about 60 wt %, 25 wt % to about 50 wt %, such as from 30 wt % to about 50 wt %, such as from about 35 wt % to about 50 wt %) based on the total weight of the nitrile rubber.

2) Where the nitrile rubber is a copolymer of isoprene and acrylonitrile, an isoprene-derived content that is from about 10 wt % to about 99.9 wt %, (such as from about 10 wt % to about 90 wt %, such as from 12 wt % to about 90 wt %, such as from about 15 wt % to about 90 wt % such as from about 20 wt % to about 80 wt %, such as from about 40 wt % to about 70 wt %, such as from about 50 wt % to about 70 wt %, such as from about 55 wt % to about 65 wt %, such as from about 60 wt % and about 65 wt %) based on the total weight of the ethylene-propylene rubber. In some embodiments, the ethylene-derived content is from about 40 wt % to about 85 wt %, such as from about 40 wt % to about 85 wt %, based on the total weight of the composition.

3) Where the nitrile rubber is a copolymer of 1,3-butadiene and acrylonitrile, a 1,3-butadiene-derived content that is from about 10 wt % to about 99.9 wt %, (such as from about 10 wt % to about 90 wt %, such as from 12 wt % to about 90 wt %, such as from about 15 wt % to about 90 wt % such as from about 20 wt % to about 80 wt %, such as from about 40 wt % to about 70 wt %, such as from about 50 wt % to about 70 wt %, such as from about 55 wt % to about 65 wt %, such as from about 60 wt % and about 65 wt %) based on the total weight of the ethylene-propylene rubber. In some embodiments, the ethylene-derived content is from about 40 wt % to about 85 wt %, such as from about 40 wt % to about 85 wt %, based on the total weight of the composition.

Suitable nitrile rubbers according to the present disclosure can have a medium to high acrylonitrile content (ACN) for an acceptable degree of fluid and fuel resistance. For example, the nitrile rubbers according to the present disclosure can have an acrylonitrile content greater than 15%, more preferably greater than 30%, even more preferably greater than 39% and most preferably, greater than 43%.

Nitrile rubbers can have a Mooney viscosy to DIN 53 523 ML 1+4 at 100° C. of from 3 to 150, such as from 30 to 130, such as from 40 to 120 Mooney units.

Nitrile rubber can be obtained from a number of commercial sources as disclosed in the Rubber World Blue Book. For example, copolymers of isoprene and acrylonitrile are available under the trade name Nipol® (Zeon Chemicals), under the trade name Perbunan® and Krynac® (ARLANXEO Deutschland GmbH). Specific examples include, NBR 6280 (from LG Chem), NBR 3280 (from LG Chem), Krynac 4450 (from Arlanxeo), Krynac 4955 (from Arlanxeo), Perbunan 4456 (from Arlanxeo), Perbunan 3481 (from Arlanxeo), Krynac 33110 (from Arlanxeo), Perbunan 28120 (from Arlanxeo), Perbunan 2895 (from Arlanxeo), Nipol DN003 (Zeon), Nipol 4580 (Zeon), Nipol DN4555 (Zeon), and Nipol DN4080 (Zeon).

In some embodiments, the NBR elastomer may be obtained in an oil extended form, with about a 5 phr to about 200 phr process oil, such as about 20 phr to about 80 phr process oil on the basis of 100 phr of elastomer.

In some preferred embodiments, the nitrile rubber used can be of the hydrogenated type referred to as “HNBR”. Hydrogenated in this disclosure can include more than 50% of the residual double bonds (RDB) present in the starting nitrile polymer/NBR being hydrogenated, such as more than 90% of the RDB are hydrogenated, such as more than 95% of the RDB are hydrogenated, such as more than 99% of the RDB are hydrogenated. The hydrogenation of nitrile rubber is well known in the art and described in, for example, U.S. Pat. Nos. 3,700,637, 4,464,515 and 4,503,196.

Suitable HNBRs according to the present disclosure can have a medium to high acrylonitrile content (ACN) for an acceptable degree of fluid and fuel resistance. In at least one embodiment, the nitrile rubbers according to the present invention have an acrylonitrile content greater than 15 wt %, such as greater than 30 wt %, such as greater than 39 wt %, such as greater than 43 wt %. Suitable nitrile rubbers are partially or fully hydrogenated and contain less than 10% of residual double bonds. In at least one embodiment, the nitrile rubbers are fully saturated and contain less than 1% of residual double bonds.

Hydrogenated nitrile rubber can be obtained from a number of commercial sources as disclosed in the Rubber World Blue Book. For example, suitable HNBRs are commercially available from Arlanxeo Deutschland GmbH under the trademark Therban®, and from Zeon Chemicals under the tradename ZeTPEl® HNBR.

The present disclosure also includes the use of carboxylated nitrile rubbers. As used throughout this specification, the term “carboxylated nitrile rubber” or XNBR includes a copolymer having repeating units derived from at least one conjugated diene, at least one α,β-unsaturated nitrile, at least one alpha-beta-unsaturated carboxylic acid or alpha-beta-unsaturated carboxylic acid derivative and optionally further one or more copolymerizable monomers α,β-unsaturated mono- or dicarboxylic acids, or their esters or amides. Exemplary α,β-unsaturated mono- or dicarboxylic acids can be fumaric acid, maleic acid, acrylic acid and methacrylic acid. Exemplary esters used of the α,β-unsaturated carboxylic acids are their alkyl esters and alkoxyalkyl esters. Exemplary esters of the α,β-unsaturated carboxylic acids are methyl acrylate, ethyl acrylate, butyl acrylate, butyl methacrylate, 2-ethylhexyl acrylate, 2-ethylhexyl methacrylate and octyl acrylate.

Carboxylated nitrile rubber (XNBR) can be obtained from a number of commercial sources as disclosed in the Rubber World Blue Book. For example, suitable XNBRs are commercially available from Arlanxeo Deutschland GmbH under the trademark Krynac X®, and from Zeon Chemicals under the tradename Nipol®.

A functionalized nitrile rubber containing one or more graft forming functional groups may be used. The aforesaid “graft forming functional groups” are different from and are in addition to the olefinic and cyano groups normally present in nitrile rubber. Carboxylic-modified nitrile rubbers containing carboxy groups and amine-modified nitrile rubbers containing amino groups are also useful for the TPV compositions described herein.

c. Butyl Rubber

In some embodiments, butyl rubber includes copolymers and terpolymers of isobutylene and at least one other comonomer. Comonomers can include isoprene, divinyl aromatic monomers, alkyl substituted vinyl aromatic monomers, and mixtures thereof. Divinyl aromatic monomers can include vinyl styrene. Alkyl substituted vinyl aromatic monomers can include α-methylstyrene and paramethylstyrene. These copolymers and terpolymers may also be halogenated such as in the case of chlorinated and brominated butyl rubber. In some embodiments, these halogenated polymers may derive from monomer such as parabromomethylstyrene.

In one or more embodiments, butyl rubber includes copolymers of isobutylene and isoprene, copolymers of isobutylene and paramethyl styrene, as described in U.S. Pat. No. 5,013,793, which is incorporated herein by reference, terpolymers of isobutylene, isoprene, and divinyl styrene, as described in U.S. Pat. No. 4,916,180, which is incorporated herein by reference, and star branched butyl rubber, as described in U.S. Pat. No. 6,255,389, which is incorporated herein by reference. These copolymers and terpolymers may be halogenated.

In one embodiment, where butyl rubber includes the isobutylene-isoprene copolymer, the copolymer may include from about 0.5 to about 30, or from about 0.8 to about 5, percent by weight isoprene based on the entire weight of the copolymer with the remainder being isobutylene.

In another embodiment, where butyl rubber includes isobutylene-paramethyl stynrene copolymer, the copolymer may include from about 0.5 to about 25, and from about 2 to about 20, percent by weight paramethyl styrene based on the entire weight of the copolymer with the remainder being isobutylene. In one embodiment, isobutylene-paramethyl styrene copolymers can be halogenated, such as with bromine, and these halogenated copolymers can contain from about 0 to about 10 percent by weight, or from about 0.3 to about 7 percent by weight halogenation.

In other embodiments, where butyl rubber includes isobutylene-isoprene-divinyl styrene, the terpolymer may include from about 95 to about 99, or from about 96 to about 98.5, percent by weight isobutylene, and from about 0.5 to about 5, or from about 0.8 to about 2.5, percent by weight isoprene based on the entire weight of the terpolymer, with the balance being divinyl styrene.

In the case of halogenated butyl rubbers, the butyl rubber may include from about 0.1 to about 10, or from about 0.3 to about 7, or from about 0.5 to about 3 percent by weight halogen based upon the entire weight of the copolymer or terpolymer.

In one or more embodiments, the glass transition temperature (Tg) of useful butyl rubber can be less than about −55° C., or less than about −58° C., or less than about −60° C., or less than about −63° C.

In one or more embodiments, the Mooney viscosity (ML₁₊₈@125° C.) of useful butyl rubber can be from about 25 to about 75, or from about 30 to about 60, or from about 40 to about 55.

Useful butyl rubber can include those prepared by polymerization at low temperature in the presence of a Friedel-Crafts catalyst as disclosed within U.S. Pat. Nos. 2,356,128 and 2,944,576. Other methods may also be employed.

In some embodiments, butyl rubber includes copolymers of isobutylene and isoprene, and copolymers of isobutylene and paramethyl styrene, terpolymers of isobutylene, isoprene, and vinylstyrene, branched butyl rubber, and brominated copolymers of isobutene and paramethylstyrene (yielding copolymers with parabromomethylstyrenyl mer units). These copolymers and terpolymers may be halogenated. Exemplary butyl rubbers include isobutylene-isoprene rubber (IIR), brominated isobutylene-isoprene rubber (BIIR), and isobutylene paramethyl styrene rubber (BIMSM).

In some embodiments, the elastomer is a copolymer of isobutylene and C₁₋₄ alkyl styrene. The elastomer is a non-halogenated elastomer comprising repeating units derived from at least one C₄ to C₇ isomonoolefin monomer and at least 3.5 mol % of repeating units derived from at least one C₄ to C₇ multiolefin monomer. The elastomer can be a blend of an ethylene propylene diene terpolymer and a copolymer of isobutylene and C₁₋₄ alkyl styrene.

In some embodiments, the butyl rubber includes one or more of the following characteristics:

1) Where butyl rubber includes the isobutylene-isoprene copolymer, the copolymer may include isoprene from about 0.5 wt % to about 30 wt % (such as from about 0.8 wt % to about 5 wt %) based on the entire weight of the copolymer with the remainder being isobutylene.

2) Where butyl rubber includes isobutylene-paramethylstyrene copolymer, the copolymer may include paramethylstyrene from about 0.5 wt % to about 25 wt % (such as from about 2 wt % to about 20 wt %) based on the entire weight of the copolymer with the remainder being isobutylene.

3) Where the isobutylene-paramethylstyrene copolymers are halogenated, such as with bromine, these halogenated copolymers can contain a percent by weight halogenation of from about 0 wt % to about 10 wt % (such as from about 0.3 wt % to about 7 wt %) based on the entire weight of the copolymer with the remainder being isobutylene.

4) Where butyl rubber includes isobutylene-isoprene-divinylbenzene, the terpolymer may include isobutylene from about 95 wt % to about 99 wt % (such as from about 96 wt % to about 98.5 wt %) based on the entire weight of the terpolymer, and isoprene from about 0.5 wt % to about 5 wt % (such as from about 0.8 wt % to about 2.5 wt %) based on the entire weight of the terpolymer, with the balance being divinylbenzene.

5) Where the butyl rubber includes halogenated butyl rubbers, the butyl rubber may include from about 0.1 wt % to about 10 wt % halogen (such as from about 0.3 wt % to about 7 wt %, such as from about 0.5 wt % to about 3 wt %) based upon the entire weight of the copolymer or terpolymer.

6) A glass transition temperature (T_{g}) that is about −55° C. or less (such as about −58° C. or less, such as about −60° C. or less, such as about −63° C. or less).

Butyl rubber can be obtained from a number of commercial sources as disclosed in the Rubber World Blue Book. For example, both halogenated and un-halogenated copolymers of isobutylene and isoprene are available under the trade name Exxon Butyl™ (ExxonMobil Chemical Co.), halogenated and un-halogenated copolymers of isobutylene and paramethylstyrene are available under the trade name EXXPRO™ (ExxonMobil Chemical Co.), star branched butyl rubbers are available under the trade name STAR BRANCHED BUTYL™ (ExxonMobil Chemical Co.), and copolymers containing parabromomethylstyrenyl mer units are available under the trade name EXXPRO 3745 (ExxonMobil Chemical Co.). Halogenated and non-halogenated terpolymers of isobutylene, isoprene, and divinylstyrene are available under the trade name Polysar Butyl™ (Lanxess; Germany).

d. Fluoroelastomeric Polymer

As used herein, “fluoroelastomer” refers to elastomeric fluorine-containing polymers having the characteristics described below, and to polymeric materials comprising them, that, upon curing, can meet the criteria of: ASTM D1566, i.e. the material will retract to less than 1.5 times its original length within one minute after being stretched at room temperature to twice its original length and held for one minute before release; ASTM D412 (tensile set parameters), and ASTM D395 (elastic requirements for compression set).

Characteristics of useful fluoroelastomers hereof include the following. Examples of fluoroelastomers include, e.g., FKM, FFKM, and FEPM fluoropolymers, e.g., as categorized under the ASTM D1418 standard (or respectively FPM, FFPM, and FEPM under the ISO 1629 standard), wherein the useful polymers typically contain about 65 mol % or more fluorine content. In various embodiments, such polymers contain about or more than 66, 67, 68, 69, 70, 71, or 72 mol %, and up to or about 75 mol % fluorine. However, in embodiments of fluoroelastomers hereof that contain alkylene monomer residues, the fluorine content can be as low as 60 wt %.

In various embodiments, fluoroelastomers in the TPV compositions hereof can have from about 60% to about 75 wt %, and more typically up to about 72 wt % fluorine content. These can be formed as copolymers of any of TFE, VI)F, and PAV/AE, with one another, and/or with E, P; or in some embodiments with HFP. Silicone-crosslinking group-terminated perfluoroalkylpolyethers may also be useful in some embodiments hereof.

As used herein in describing non-CSM monomer content of fluoroelastomers, “alkylene” refers to residues of C2-C4 alkylenes, typically propylene and/or ethylene. The non-fluorinated alkylene residue content of fluoroelastomers hereof is typically 25% mol. % or less, generally about or less than 20, 15, 10 or 5 mol. %; and generally about or more than 1, 2, 3, 5, or 10 mol. %. Typical alkylene residue content can be from about 1 to about 15 mol. %, although an increased amount of alkylene residues can be present so as to provide a fluoroelastomer having as low as 60 wt. % fluorine content.

In various embodiments, a fluoroelastomer hereof can contain cure-site monomer (CSM) residues or can be CSM-free. In fluoroelastomers hereof that contain more than 70 mol % fluorine, cure-site monomers can be used, but are optional; in those that contain 70 mol % or less fluorine, CSM are typically present. In various embodiments, aside from CSM content, the fluoroelastomer can be a perfluoroelastomer.

As used herein, “FKM” fluoroelastomer refers to those fluoroelastomers belonging to the ASTM “FKM” designation, and particularly those that comprise TFE and VDF residues and either or both of alkylene and PAV/AE residues. An FKM elastomer can contain or can be free of HFP monomer residues. Though any of FKM Types 1-5 can be used in various embodiments hereof, in some embodiments, a Type 2 or Type 5 FKM can be used. See D. Hertz, Jr, “Fluoroelastomers,” in K. C. Baranwal & H. L. Stephens (eds.), Basic Elastomer Technology, chapt. 11.D. (ACS 2001); and D. Hertz, Jr., Fluorine-Containing Elastomers (Seals Eastern, Inc.) (available on the World Wide Web at sealseastern.com/PDF/FluoroAcsChapter.pdf).

In FKM fluoroelastomers hereof, the mole ratio of TFE:VDF is generally from about 15:85 to about 70:30. In some embodiments, the FKM fluoroelastomer can contain cure site monomer residue(s). In various embodiments, the FKM fluoroelastomer can contain only TFE and VDF residues and either or both of alkylene and PAV/AE residues, and optionally CSM residue(s). In an FKM fluoroelastomer hereof, the content of TFE is typically 15 mol. % or more, generally 20, 25, 30, 35, 40, 45, or 50 or more; typically 85 mol. % or less, or less than or equal to 80% or 75%. In various embodiments, the TFE content can be from about 15 to about 85 mol. % TFE, or from about 25 to about 80 mol. %, or from about 50 to about 75 mol. %. In PAV/AE-containing fluoroelastomer polymers hereof, the mole ratio of TFE:PAV/AE is typically from about 40:60 to about 90:10.

As used herein, “FFKM” fluoroelastomer refers to those fluoroelastomers belonging to the ASTM “FFKM” designation, and particularly those that comprise TFE and PAV/AE residues, typically PAVE residues, with from 30 to 87% mol. % TFE, but that are generally free of VDF and alkylene residues. From 42 to 80 mol. % PAV/AE is typically present therein. In FFKM fluoroelastomers hereof, the mole ratio of TFE:PAV/AE is typically from about 40:60 to about 90:10. In some embodiments, the FFKM fluoroelastomer can contain cure site monomer residue(s). In various embodiments, the FFKM fluoroelastomer can contain only TFE and PAV/AE monomer residues, and optionally CSM residue(s). “FFKM-class” fluoroelastomers hereof include perfluoroalkylpolyethers, generally free of VDF and alkylene residues, that contain cure-site monomer(s); in various embodiments, these exhibit performance characteristics within the ranges of those exhibited by FFKM fluoroelastomers. In some embodiments of FFKM-class fluoroelastomers, the CSM can be a terminal silicone group(s), such as is found in silicone-crosslinking-group-terminated perfluoroalkylpolyethers, e.g., Shin-Etsu Sifel. Silicone CSMs are further described below in the discussion of CSMs.

As used herein, “FEPM” fluoroelastomer refers to those fluoroelastomers belonging to the ASTM “FEPM” designation, and particularly those that comprise TFE and alkylene residues, with at least 50 mol % TFE, but that are generally free of VDF residues. The alkylene types useful in FEPM fluoroelastomers is as described above for FKM fluoroelastomers; in various embodiments, the alkylene content of FEPM is also as described therein. In some embodiments, the FEPM fluoroelastomer can contain cure site monomer residue(s). In various embodiments, the FEPM fluoroelastomer can contain only TFE and alkylene monomer residues, and optionally CSM residue(s). “FEPM-class” fluoroelastomers hereof include TFE-alkylene-PAV/AE fluoropolymers, which are generally free of VDF residues; in various embodiments, these exhibit performance characteristics within the ranges of those exhibited by FEPM fluoroelastomers. In some embodiments, the FEPM-class fluoroelastomer can contain cure site monomer residue(s). In various embodiments, the FEPM-class fluoroelastomer can contain only TFE, alkylene, and PAV/AE monomer residues, and optionally CSM residue(s). One useful example of an FEPM-class fluoroelastomer is DuPont Viton ETP.

In some embodiments, FKM, FFKM, and FEPM polymers can further comprise residues of other non-CSM perfluoro-monomers, e.g., perfluoro-alkyldiol residues, HFP residues, and the like. Such other monomers, where used, are typically present in an amount that is collectively about 20, 15, 10, or 5 mol. % or less, and at least or about 0.1, 0.5, 1, 2, 3, or 5 mol. %.

Representative examples of fluoroelastomers include those listed in Table 3.

TABLE 3
Exemplary
Fluoroelastomers*
ASTM

| | | Exemplary |
|---|---|---|
| | | Commercial |
| Type | Fluoroelastomer (Family: Example) | Type(s) |
| FKM | Poly(TFE-co-VDF-co-E/P): | AGC AFLAS M ® or |
| | Poly(TFE-co-VDF-co-P) | AFLAS S 0; |
| | | DuPont VITON TBR- |
| | | 501C ® or VITON |
| | | IBR-401C ® |
| FKM | Poly(TFE-co-VDF-co-PAV/AE): | |
| | Poly(TFE-co-VDF-co-PMVE) | DuPont VITON |
| | | GLT ®, |
| | | VITON GFLT ®, |
| | | or VITON GBLT ® |
| FKM | Poly(TFE-co-VDF-co-E/P-co-PAV/AE): | |
| | Poly(TFE-co-VDF-co-E-co-PMVE) | |
| FFKM | Poly(TFE-co-PAV/AE): | |
| | Poly(TFE-co-PMVE) | DuPont KALREZ ®; |
| | | Greene Tweed |
| | | CHEMRAZ ®; PPE |
| | | PERLAST ® |
| FEPM | Poly(TFE-co-E/P): | |
| | Poly(TFE-co-P) | AGC AFLAS |
| | | 100 ® or |
| | | AFLAS 150 ®; |
| | | DuPont VITON |
| | | TBR ®; Greene |
| | | Tweed |
| | | FLUORAZ; Dyneon |
| | | BRE ® or FLUOREL |
| | | II ® |
| FEPM- | Poly(TFE-co-E/P-co-PAV/AE): | |
| class | | |
| | Poly(TFE-co-E-co-PMVE) | DuPont VITON |
| | | ETP ® |
| FFKM- | Silicone-crosslinking-group-terminated | |
| class | perfluoroalkylpolyethers: | |
| | Silicone-crosslinking-group-terminated | Shin-Etsu SIFEL ® |
| | perfluoroisopropylpolyethers | |

*These polymers include versions thereof in which a cure-site monomer residue(s) is also present.
Company names: AGC = Asahi Glass Co., Ltd (Tokyo, JP); DuPont (Wilmington, DE, US); Greene Tweed & Co. Ltd. (Nottingham, UK); PPE = Precision Polymer Engineering Ltd. (Blackburn, UK); Shin-Etsu Chemical Co., Ltd. (Tokyo, JP)

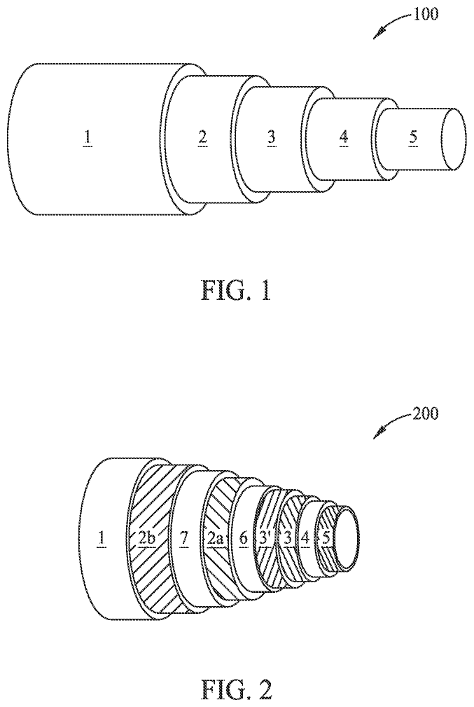

Further examples of FKM fluoroelastomers include: DAI-EL® (e.g., Dai-El G999; Daikin Industries, Ltd., Osaka, JP), TECNOFLON® (Solvay-Solexis S.p.A., Bollate, Mich., IT), NOXTITE® (UNIMATEC Chemicals Europe GmbH & Co. KG, Weinheim, Del.), FLUOREL® and DYNEON® (e.g., Dyneon FC, FE, FG, FT, and FX grades; 3M Dyneon LLC, Oakdale, Minn., US). As used herein “FKM fluoroelastomers” are distinguished from “HFP-VDF FKM” fluoropolymers, which can be used in some embodiments hereof. “HFP-VDF FKM” are defined herein as fluoropolymers whose compositions fall within region 101 of FIG. 1, and that can optionally further contain up to about 20 mol %, 10 mol % or 5 mol %, and/or at least or about 0.1 mol %, 0.2 mol %, 0.3 mol %, 0.5 mol %, or 1 mol %, of other monomers (whether CSM and/or non-CSM monomers), in which case the mole ratio of HFP:VDF or of HFP:VDF:TFE is unchanged.

Further examples of useful FFKM perfluoroelastomers include, PAROFLUOR® (Parker Hannifin Corp., Mayfield Heights, Ohio, US), SIMRIZ® (Freudenberg-NOK, Plymouth, Mich., US), and ZALAK® (DuPont). Additional examples of useful fluoroelastomers include those described in US Publication No. 2007/0004862 to Park et al.

Fluoroelastomeric polymers of the present can be synthesized using any suitable catalyst under polymerization conditions. Other suitable fluorothermoplastic polymers are described in U.S. Patent Publication No. 2009/0203846, which is incorporated by referenced.

e. Acrylic Acid-Ester Copolymer Rubber

Typical acrylic rubbers have an C₁-C₁₀ alkyl group in combination with one or more groups chosen from C₂-C₃ olefin, carboxyl, hydroxyl, epoxy, halogen, and the like. Rubbers which do not have a reactive site and are not curable include polymers of ethyl acrylate, butyl acrylate, ethyl-hexyl acrylate, and the like; and also copolymers of ethylene and the aforementioned alkyl acrylates. Such rubbers can be absent from the TPV of this invention, unless used as a diluent. The essential rubber contains halogen functionality, the other(s) being chosen from carboxyl, epoxy and hydroxy. When a repeating unit derived from an olefin is chosen, the olefin preferably has from 2 to 6 carbon atoms. A typical curable rubber may include an ethylene, propylene or butylene repeating unit, the molar ratio of such olefin units to acrylate repeating units typically being less than 2, preferably being in the range from 0.5 to 1.5.

Representative curable rubbers having a vinyl chloroacetate group are AR-71 and AR-72LS, available from Zeon Chemical Division of Nippon Zeon, and Europrene® R, L and S from Enichem; a representative curable rubber having a benzylic chloride group is Hytemp® 4051 also available from Zeon Chemical.

A curable rubber with a hydroxy reactive site is provided by a comonomer of a hydroxyl functional acrylate having from about 2 to about 20 and desirably from 2 to about 10 carbon atoms. A specific example of a hydroxy functionalized acrylic rubber is Hytemp 4404 from Nippon-Zeon.

A curable rubber with a pendent epoxy reactive site is provided by an unsaturated oxiranes such as oxirane acrylates wherein the oxirane group can contain from about 3 to about 10 carbon atoms and wherein the ester group of the acrylate is an alkyl having from 1 to 10 carbon atoms with a specific example being glycidyl acrylate. Another choice of unsaturated oxirane monomer is an oxirane alkenyl ether wherein the oxirane and alkenyl groups may each have from 3 to about 10 carbon atoms, as typified by allyl glycidyl ether. Examples of epoxy functionalized acrylic rubbers include Acrylate AR-53 and Acrylate AR31 from Nippon-Zeon, and the like.

A curable rubber with a carboxyl reactive site is provided by a C₂-C₁₅, preferably C₂-C₈, monoolefinically unsaturated acid. Examples of acid functionalized acrylic rubbers include terpolymers of ethylene-acrylate-carboxylic acids such as Vamac G and Vamac GLS from DuPont, and other acrylates with carboxyl functionality.

f. Ethylene Vinyl Acetate

The amount used of the α-olefin-vinyl acetate copolymer in the crosslinkable TPE or TPV compositions of the invention according to embodiment 1 is from 10 to 90% by weight, preferably from 15 to 70% by weight, particularly preferably from 15 to 60% by weight of the composition.

The α-olefin-vinyl acetate copolymers used as an elastomer phase can generally have vinyl acetate contents of from 20 to 98% by weight, preferably from 40% to 90% by weight.

The α-olefin-vinyl acetate copolymers used in some embodiments have high vinyl acetate content, such as greater than 40% by weight, based on the total weight of the α-olefin-vinyl acetate copolymer, such as vinyl acetate content of greater than 50% by weight, based on the total weight of the α-olefin-vinyl acetate copolymers. The vinyl acetate content of the α-olefin-vinyl acetate copolymers used can be from greater than 40% by weight to 98% by weight, such as from greater than 50% by weight to 98% by weight, and the α-olefin content can be from 2% by weight to less than 60% by weight, such as from 2% by weight to less than 50% by weight, where the total amount of vinyl acetate and α-olefin is 100% by weight.

The α-olefin-vinyl acetate copolymer used can comprise not only the monomer units based on the α-olefin and on vinyl acetate, but also one or more further comonomer units (e.g. terpolymers), e.g. based on vinyl esters and/or on (meth)acrylates. The proportion of the further comonomer units—if indeed further comonomer units are present in the α-olefin-vinyl acetate copolymer—is up to 10% by weight, based on the total weight of the α-olefin-vinyl acetate copolymer, whereupon the proportion of the monomer units based on the α-olefin decreases correspondingly. It is therefore possible by way of example to use α-olefin-vinyl acetate copolymers which are composed of from 40% by weight to 98% by weight of vinyl acetate, from 2% by weight to ≤60% by weight of α-olefin, and from 0% to 10% by weight of at least one further comonomer, where the total amount of vinyl acetate, α-olefin and the further comonomer is 100% by weight.

α-Olefins that can be used in the α-olefin-vinyl acetate copolymers used according to the invention are any suitable α-olefin. For example, the α-olefin may be selected from ethene, propene, butene, such as n-butene, isobutene, pentene, hexene, such as 1-hexene, heptene, such as 1-heptene and octene, such as 1-octene. It is also possible to use higher homologues of the α-olefins mentioned as α-olefins in the α-olefin-vinyl acetate copolymers used according to the invention. The α-olefins can moreover have substituents, such as C₁-C₅-alkyl moieties. However, it may be preferable that the α-olefins have no further substituents. It is moreover possible to use mixtures of two or more different α-olefins in the α-olefin-vinyl acetate copolymers used. However, it may be preferable not to use mixtures of different α-olefins. Exemplary α-olefins are ethene and propene, and it is particularly preferable here to use ethene as α-olefin in the α-olefin-vinyl acetate copolymers used according to the invention. The α-olefin-vinyl acetate copolymer may be used in the crosslinkable compositions of the present disclosure therefore can involve an ethylene-vinyl acetate copolymer.

Particularly preferred ethylene-vinyl acetate copolymers have a vinyl acetate content of from ≥40% by weight to 98% by weight, such as from ≥50% by weight to 98% by weight, and an ethylene content of from 2% by weight to ≤60% by weight, such as from 2% by weight to ≤50% by weight, where the entirety of vinyl acetate and ethylene is 100% by weight.

The α-olefin-vinyl acetate copolymer used according to the invention, such as ethylene-vinyl acetate copolymer, can be prepared by a solution polymerization process at a pressure of from 100 to 700 bar, such as at a pressure of 100 to 400 bar. The solution polymerization process may be carried out at temperatures of from 50 to 150° C., generally using free-radical initiators.

The ethylene-vinyl acetate copolymers may have high vinyl acetate contents and are usually termed “EVM copolymers”, where the “M” in the name indicates the saturated main methylene chain of the EVM.

Suitable preparation processes for the α-olefin-vinyl acetate copolymers used according to the present disclosure are mentioned by way of example in EP-A-0 341 499, EP-A 0 510 478 and DE-A 38 25 450.

The α-olefin-vinyl acetate copolymers can have high vinyl acetate content and can be prepared by the solution polymerization process at a pressure of from 100 to 700 bar, and may have low degrees of branching and low viscosities. The α-olefin-vinyl acetate copolymers can have a uniformly random distribution of their units (α-olefin and vinyl acetate).

The MFI values (g/10 min), measured according to ISO 1133 at 190° C. using a load of 21.1 N, of the α-olefin-vinyl acetate copolymers can be from 1 to 40, such as from 1 to 10, such as from 2 to 6. The Mooney viscosities to DIN 53 523 ML 1+4 at 100° C. can be from 3 to 50, preferably from 4 to 40, Mooney units.

The crosslinkable compositions according to the present disclosure can use ethylene-vinyl acetate copolymers, where these are by way of example commercially available with trade mark Levapren® or Levamelt® from ARLANXEO Deutschland GmbH, and Elvaloy® (from Dupont). α-Olefin copolymers can be the ethylene-vinyl acetate copolymers Levamelt® 400, Levamelt® 450, Levamelt® 452, Levamelt® 456, Levamelt® 500, Levamelt® 600, Levamelt® 700, Levamelt® 800 and Levamelt® 900, having 60±1.5% by weight of vinyl acetate, 70±1.5% by weight of vinyl acetate, 80±2% by weight of vinyl acetate and, respectively, 90±2% by weight of vinyl acetate, and the corresponding Levapren® grades.

In some embodiments, ethylene-vinyl acetate copolymers are pre-crosslinked in a controlled manner in an addition process stage. Such pre-crosslinked ethylene-vinyl acetate copolymers can be dispersed in a crystalline thermoplastic resin to produce a crosslinkable TPE or TPV composition.

The pre-crosslinked EVA copolymers, where these are by way of example commercially available with trade mark Levapren® XL from ARLANXEO Deutschland GmbH. α-Olefin copolymers whose use is particularly preferred are the pre-crosslinked ethylene-vinyl acetate copolymers Levapren® 500 XL, Levapren® 600 XL, Levapren® 700 XL, Levapren® 800 XL, Levapren® 500 PXL, Levapren® 600 PXL, Levapren® 700 PXL, and Levapren® 800 PXL, having 60±1.5% by weight of vinyl acetate, 70±1.5% by weight of vinyl acetate, 80±2% by weight of vinyl acetate and, respectively, 90±2% by weight of vinyl acetate.

Ethylene vinyl acetate polymers of the present disclosure can have a vinyl chloroacetate group such as AR-71 and AR-72LS, available from Zeon Chemical Division of Nippon Zeon, and Europrene® R, L and S from Enichem. An ethyl vinyl acetate can have a benzylic chloride group such as Hytemp® 4051 also available from Zeon Chemical.

Acrylate AR-71 is a copolymer of ethyl acrylate and a lower alkyl, C1-C4, vinyl chloro acetate in a weight ratio of about 95:5.

### Additional Additives

An elastomer-polymer blend of the present disclosure may optionally include one or more additional additives.

A crosslinked elastomer-polymer blend may contain minor amounts of one or more additives such as pigments, heat stabilizers, process stabilizers, metal deactivators, flame-retardants and/or reinforcement fillers. The reinforcement fillers may e.g. include glass particles, glass fibers, mineral fibers, talcum, carbonates, mica, silicates, and metal particles.

Additionally or alternatively, a crosslinked elastomer-polymer blend may contain minor amounts of one or more additives selected from an antistatic agent, dye, UV light stabilizer, nucleating agent, filler, slip agent, plasticizer, anti-H₂S metal oxide, fire retardant, lubricant, processing aide, and viscosity control agent.

### Crosslinking Processes and Crosslinking Agents for Preparing TPV

Any vulcanizing agent that is capable of curing or crosslinking the rubber employed in preparing the TPV may be used. Crosslinking can be accomplished using a crosslinking agent that is a phenolic resin, hydrosilylation curative (e.g., silane-containing curative), a peroxide with a coagent, a moisture cure via silane grafting, or a C—H insertion agent (e.g., an azide), sulfur curatives. For example, a phenolic cure system can be one disclosed in U.S. Pat. Nos. 2,972,600, 3,287,440, 5,952,425 and 6,437,030, which are incorporated by reference.

In some embodiments, the TPV is cured using a phenolic resin vulcanizing agent. The phenolic resin curatives can be referred to as resole resins, which are made by the condensation of alkyl substituted phenols or unsubstituted phenols with aldehydes, preferably formaldehydes, in an alkaline medium or by condensation of bi-functional phenoldialcohols. The alkyl substituents of the alkyl substituted phenols may contain 1 to about 10 carbon atoms. Dimethylolphenols or phenolic resins, substituted in para-positions with alkyl groups containing 1 to about 10 carbon atoms can be used. In some embodiments, a blend of octyl phenol and nonylphenol-formaldehyde resins are employed. The blend may include from 25 wt % to 40 wt % octyl phenol and from 75 wt % to 60 wt % nonylphenol, such as the blend includes from 30 wt % to 35 wt % octyl phenol and from 70 wt % to 65 wt % nonylphenol. In some embodiments, the blend includes about 33 wt % octylphenol-formaldehyde and about 67 wt % nonylphenol formaldehyde resin, where each of the octylphenol and nonylphenol include methylol groups. This blend can be solubilized in paraffinic oil at about 30% solids.

Useful phenolic resins may be obtained under the tradenames SP-1044, SP-1045 (Schenectady International; Schenectady, N.Y.), which may be referred to as alkylphenol-formaldehyde resins (also available in a 30/70 weight percent paraffinic oil solution under the trade name HRJ-14247A). SP-1045 is believed to be an octylphenol-formaldehyde resin that contains methylol groups. The SP-1044 and SP-1045 resins are believed to be essentially free of halogen substituents or residual halogen compounds. By “essentially free of halogen substituents,” it is meant that the synthesis of the resin provides for a non-halogenated resin that may only contain trace amounts of halogen containing compounds.

The curative may be used in conjunction with a cure accelerator, a metal oxide, an acid scavenger, and/or polymer stabilizers. Exemplary cure accelerators include metal halides, such as stannous chloride, stannous chloride anhydride, stannous chloride dihydrate and ferric chloride. The cure accelerator may be used to increase the degree of vulcanization of the TPV, and in some embodiments may be added in an amount of less than 1 wt % based on the total weight of the TPV. In some embodiments, the cure accelerator comprises stannous chloride. In some embodiments, the cure accelerator is introduced into the vulcanization process as part of a masterbatch.

In some embodiments, the curative, such as a phenolic resin, is used in conjunction with an acid scavenger. The acid scavenger may be added downstream of the curative after the desired level of cure has been achieved. Exemplary acid scavengers include hydrotalcites. Both synthetic and natural hydrotalcites can be used. Exemplary natural hydrotalcite can be represented by the formula Mg₆Al₂(OH)₁₋₆ CO₃.4H₂O. Synthetic hydrotalcite compounds, which can have the formula: Mg_{4.3}Al₂(OH)_{12.6}CO₃MH₂O or Mg_{4.5}Al₂(OH)₁₃CO_{3.3}.5H₂O, can be obtained under the tradenames DHT-4A™ or Kyowaad™ 1000 (Kyowa, Japan). Another commercial hydrotalcite compound is that available under the trade name Alcamizer™ (Kyowa).

In some embodiments, metal oxides may be added to the vulcanization process. It is believed that the metal oxide can act as a scorch retarder in the vulcanization process. Useful metal oxides include zinc oxides having a mean particle diameter of about 0.05 to about 0.15 μm. Useful zinc oxide can be obtained commercially under the tradename Kadox™ 911 (Horsehead Corp.).

The curative, such as a phenolic resin, may be introduced into the vulcanization process in a solution or as part of a dispersion. In preferred embodiments, the curative is introduced to the vulcanization process in an oil dispersion/solution, such as a curative-in-oil or a phenolic resin-in-oil, where the curative/resin is dispersed and/or dissolved in a process oil. The process oil used may be a mineral oil, such as an aromatic mineral oil, naphthenic mineral oil, paraffinic mineral oils, or combination thereof.

The vulcanizing agent can be present in an amount effective to produce the desired amount of cure within the rubber phase. In certain embodiments, the vulcanizing agent is present in an amount of from 0.01 phr to 50 phr, or from 0.05 phr to 40 phr, or from 0.1 phr to 30 phr, or from 0.5 phr to 25 phr, or from 1.0 phr to 20 phr, or from 1.5 phr to 15 phr, or from 2.0 phr to 10 phr.

Additionally or alternatively, a crosslinking agent can be a peroxide. In some embodiments, peroxide curatives include organic peroxides. Examples of organic peroxides include di-tert-butyl peroxide, dicumyl peroxide, t-butylcumyl peroxide, α,α-bis(tert-butylperoxy) diisopropyl benzene, 2,5-dimethyl-2,5-di(t-butylperoxy)hexane (DBPH), 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, 2,5-dimethyl-2,5-di(tert-butylperoxy) hexyne-3, and mixtures thereof. Also, diaryl peroxides, ketone peroxides, peroxydicarbonates, peroxyesters, dialkyl peroxides, hydroperoxides, peroxyketals and mixtures thereof may be used. In some embodiments, the peroxide curatives are employed in conjunction with a coagent. Examples of coagents include triallylcyanurate, triallyl isocyanurate, triallyl phosphate, sulfur, N-phenyl bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, cyclohexane dimethanol diacrylate ester, polyfunctional methacrylates, acrylate and methacrylate metal salts, and oximes such as quinone dioxime. Suitable peroxide curatives useful in the preparation of TPVs according to the present disclosure include dicumyl peroxide, di-tert.-butyl peroxide, benzoyl peroxide, 2,2′-bis (tert.-butylperoxy diisopropylbenzene (Vulcup® 40KE), benzoyl peroxide, 2,5-dimethyl-2,5-di(tert-butylperoxy)-hexyne-3, 2,5-dimethyl-2,5-di(benzoylperoxy)hexane, (2,5-bis(tert.-butyl peroxy)-2,5-dimethyl hexane and the like can be used. An exemplary peroxide curing agent is commercially available under the trademark Vulcup® 40KE. The peroxide curing agent can be used in an amount of 0.2 to 7 parts per hundred parts of rubber (phr), preferably 1 to 3 phr.

In some embodiments, the crosslinking agent can include a peroxide, a vinyl silane, and a moisture cure catalyst. A moisture cure catalyst can be a sulfonic ester or dibutyl tin laurate. For example, an elastomer-polymer blend can include from about 1 wt % to about 4 wt % vinyl silane and from about 1 wt % to about 4 wt % moisture cure catalyst.

Alternatively, the crosslinking agent can be a moisture cure catalyst, such as a sulfonic ester or dibutyl tin laurate. For example, an elastomer-polymer blend can include from about 1 wt % to about 4 wt % moisture cure catalyst.

Alternatively, the crosslinking agent can be a C—H insertion curing agent. A C—H insertion curing agent can be one or more of an alkyl or aryl azide, acyl azide, azidoformate, sulfonyl azide, phosphoryl azide, phosphinic azide, or silylazide. Examples of suitable azides are provided in U.S. Pat. No. 6,277,916 B1.

In some embodiments, the elastomers are crosslinked via “dynamic vulcanization”. The term “dynamic vulcanization” means vulcanization or curing of a curable rubber blended with a thermoplastic resin under conditions of shear at temperatures sufficient to plasticize the mixture. In some embodiments, the rubber is simultaneously crosslinked and dispersed within the thermoplastic resin. Depending on the degree of cure, the rubber to thermoplastic resin ratio, compatibility of the rubber and thermoplastic resin, the kneader type and the intensity of mixing (shear rate), other morphologies, such as co-continuous rubber phases in the plastic matrix, are possible.

### Additives

The TPE or TPV may further comprise one or more additives. These additives may be present in addition to, or in place of the additives which may be present in the rubber and thermoplastic resin compositions used to make the TPV. Suitable additives include, but are not limited to, plasticizers, fillers, crosslinking agent and processing aids.

The TPV composition may also include reinforcing and non-reinforcing fillers, UV stabilizers, antioxidants, stabilizers, antiblocking agents, anti-static agents, waxes, foaming agents, pigments, flame retardants and other processing aids known in the rubber compounding art. Fillers and extenders that can be utilized include conventional inorganics such as calcium carbonate, clays, silica, talc, titanium dioxide, carbon black, as well as organic and inorganic nanoscopic fillers. Fillers, such as carbon black, may be added as part of a masterbatch, and for example may be added in combination with a carrier such as polypropylene.

In one or more embodiments, the TPV includes at least about 5 wt %, 6 wt %, 7 wt %, 8 wt %, 9 wt %, or 10 wt % or of one or more fillers, such as calcium carbonate, clays, silica, talc, titanium dioxide, carbon black, and blends thereof, based on the weight of the TPV. In some embodiments, the TPV includes clay and/or carbon black in an amount ranging from a low of about 5 wt %, 6 wt %, 7 wt %, 8 wt %, 9 wt %, or 10 wt % to a high of about 15 wt %, 16 wt %, 17 wt %, 18 wt %, 19 wt %, or 20 wt %, based on the total weight of the TPV.

### Compatibilizers

In some embodiments, the present TPE or TPV compositions may further include a compatibilizer. A thermoplastic compatibilizer for the rubber phase is useful in the present TPV compositions because of the decreased time for dispersion of the rubber as well as the decrease in particle size of the rubber domains, all while maintaining equivalent or better mechanical properties. Non-limiting examples of compatibilizers include styrenic block copolymers (such as styrene-butadiene-styrene and styrene-ethylene-butylene-styrene), copolymers of alpha-olefins (such as ethylene-octene, ethylene-butene, ethylene-propylene, and copolymers comprising olefin monomeric units and aromatic units, e.g., alpha-olefins with styrenics such as ethylene-styrene copolymers), and combinations thereof. The compatibilizers can be block copolymers, random copolymers, or pseudorandom copolymers.

In certain embodiments, the TPE or TPV compositions contain a diblock copolymer having isotactic polypropylene blocks and ethylene-propylene blocks. Examples of block copolymers contain isotactic polypropylene in a range from about 5 wt % to about 90 wt %. In certain embodiments, the block copolymer contains ethylene in the ethylene-propylene blocks in a range between about 5 wt % to about 70 wt %. In certain embodiments, the diblock copolymer is present in the TPV composition in an amount in a range from about 0.5 wt % to about 30 wt %, such as from about 1 wt % to about 20 wt % or from about 3 wt % to about 10 wt %. Exemplary polyolefin compatibilizers include but are not limited to Intune™ D5535, Intune™ D5545, and Intune™ 10510, Infuse™ 9000, Infuse™ 9007, Infuse™ 9100, Infuse™ 9107 available from The Dow Chemical Company of Midland, Mich.

In certain embodiments, the TPE or TPV compositions with compatibilizers show uniform dispersion of rubber domains within the thermoplastic vulcanizate composition, allowing the composition to be extruded into articles of the TPV compositions described herein having a thickness of about 2 mm or greater, such as a thickness of about 6 mm or greater, a thickness of about 10 mm or greater, or a thickness of about 15 mm or greater. Extruded articles of the TPV compositions described can have thicknesses of about 8 mm or greater and still exhibit effective cooling (e.g. cooling from an outer surface of the cross section to an inner surface of the cross section) at extrusion temperatures without sacrificing mechanical strength.

In some embodiments, the TPE or TPV compositions comprising a blend of a crystalline thermoplastic polyolefin with an elastomer of substantial polarity further comprises a compatibilizer that is typically a graft or block copolymer that includes at least one olefinic polymer portion and at least one polar polymer portion. The polymer portions can be in the form of blocks. The olefinic polymer portion is formed of an olefinic polymer, and the polar polymer portion is formed of a polar polymer. The olefinic polymer portion should be selected to be compatible with the olefinic polymer, and the polar polymer portion can be selected to be compatible with the polar polymer. For example, if the olefinic polymer is polyethylene, the olefinic polymer portion of the compatibilizer is also polyethylene.

Preferably, the polar polymer portion of the compatibilizer includes functional groups that are the same as the functional groups in the polar polymer. For example, if the polar polymer is ethylene vinyl acetate, the polar polymer portion of the compatibilizer includes vinyl acetate monomers.

The polymer compositions can include from about 1 weight percent to about 30 weight percent compatibilizer based on the total composition.

In some embodiments, the olefinic polymer portions and polar polymer portions of the compatibilizer can be directly chemically bonded or they can be connected by a linking agent that is chemically bonded to an olefinic polymer portion and an adjacent polar polymer portion.

In some embodiments, when a linking agent is not used, the compatibilizer can be formed by reacting two polymers that contain functional groups that react to provide the compatibilizer. This reaction can occur in a mixture that contains the olefinic polymer and the polar polymer.

Alternatively, the compatibilizer can first be formed and then added to a mixture that contains the olefinic polymer and the polar polymer. For example, an amine and/or epoxy containing polymer, such as a nitrile rubber, can be reacted with an acid or anhydride containing polyolefin, such as a polypropylene or a polyethylene.

In some embodiments, an isocyanate containing polyester (typically having a low molecular weight) can be reacted with an acid, anhydride or epoxy containing polyolefin. A compatibilizer can be formed by reacting an epoxy containing terpolymer of ethylene, vinyl acetate and carbon monoxide with a malefic acid modified polypropylene. A compatibilizer can be formed by reacting an ethylene methyl acrylate acid containing polar polymer with an epoxy containing styrene ethylene butylene styrene block copolymer.

In some embodiments, the functional groups that react to form the compatibilizer are at the terminus of the polymers. A block copolymer comprising at least one segment each of nitrile rubber and an olefin polymer, said copolymer being derived from an olefin polymer containing one or more graft forming functional groups and a nitrile rubber containing one or more graft forming functional groups.

In some embodiments, the compatibilizers are formed in situ through the reaction between a molten maleated polyolefin and an amine terminated NBR. The amine end groups can be introduced into NBR by LiAlH₄ reduction. Such in situ formed compatibilizers are described in U.S. Pat. No. 4,299,931.

In some embodiments, the NBR/PP TPV comprises an in situ formed compatibilizing agent formed through the reaction between a maleated polypropylene and an amine-terminated liquid nitrile rubber blends, the molecular weight of the amine-terminated liquid nitrile rubber is 500 to 50,000, modified polypropylene in an amount of 0.5 to 25 parts (100 parts by mass of crystalline polypropylene basis), the amount of amine-terminated liquid nitrile rubber 0.5 to 25 parts (by mass 100 parts of nitrile-butadiene rubber).

In some embodiments, the NBR/PE TPV comprises an in situ formed compatibilizing agent is formed through the reaction between a maleated polyethylene and an amine-terminated liquid nitrile rubber blends, and the molecular weight of the amine-terminated liquid nitrile rubber is 500 to 50,000.

In some embodiments, the compatibilizer is either formed in situ or prepared separately added to the TPV composition.

In some embodiments, the maleated polyolefin is present in an amount of from 0.5 to 25 parts (100 parts by mass of crystalline polypropylene basis), and the amount of amine-terminated liquid nitrile rubber 0.5 to 25 parts (by mass 100 parts of nitrile-butadiene rubber).

In some preferred embodiments, the amine terminated liquid nitrile rubber of the compatibilizer has an amine hydrogen equiv wt. of from 50 to 5,000, such as 100 to 3000, such as 500 to 3,000, such as for example 900. In some embodiments, the amine terminated liquid nitrile rubber of the compatibilizer has an amine value from 1 to 500, such as from 20 to 200, such as from 30 to 250, such as for example about 62. In some embodiments, the amine terminated liquid nitrile rubber of the compatibilizer has a viscosity at 27° C. from 10,000 to 1,000,0000 cps, such as from 50,000 to 750,000, such as from 100,000 to 600,000, such as about 200,000. Exemplary examples of amine terminated nitrile rubbers include Hypro® ATBN available from Emerald performance materials. Examples include Hypro® 1300X16 ATBN, Hypro® 1300X35 ATBN, Hypro® 1300x45 ATBN.

In some embodiments, the compatibilizer blend comprises a maleated polyolefin with a maleic anhydride grafting level greater than 0.1 wt %, such as greater than 0.5 wt %, such as greater than 1 wt %. Examples of commercially-available acid anhydride polyolefins that can be used in accordance with the present disclosure, include, but are not limited to, Amplify™ GR functional polymers, available from the Dow Chemical Company; Fusabond® polymers, available from the DuPont Company; Kraton® FG and RP polymers, available from Kraton Polymers LLC; Lotader® polymers available from Arkema, Inc.; Polybond® and Royaltuf® polymers, available from Chemtura Corp.; and Exxelor polymers available from the ExxonMobil Corp. Preferred examples include, Polybond 3000 (MAH level: 1.2 wt %) from Chemtura, Fusabond E100 from Dupont, Amplify GR205 from Dow, Exxelor PE 1040 from ExxonMobil, Exxelor PO 1015 from ExxonMobil.

### Processing Oils/Plasticizers

Processing oils that can be used include mineral oils (such as Group 1 mineral oils or Group II mineral oils), petroleum-based oils, synthetic oils, low molecular weight aliphatic esters, ether ester, other suitable oils, or a combination thereof. These oils may also be referred to as plasticizers or extenders. Mineral oils may include aromatic, naphthenic, paraffinic, isoparaffinic oils, synthetic oils, and combinations thereof. The mineral oils may be treated or untreated. One example of a mineral oil useful in certain embodiments of the present TPV compositions includes Paramount 6001R available from Chevron Products Company of San Ramon, Calif.

Many additive oils are derived from petroleum fractions and have particular ASTM designations depending on whether they fall into the class of paraffinic, naphthenic, or aromatic oils. According to the American Petroleum Institute (API) classifications, base stocks are categorized in five groups based on their saturated hydrocarbon content, sulfur level, and viscosity. Group I oils and group II oils are derived from crude oil via processing, such as solvent extraction, solvent or catalytic dewaxing, and hydroisomerization, hydrocracking and isodewaxing, isodewaxing and hydrofinishing. Synthetic oils include alpha olefinic synthetic oils, such as liquid polybutylene. Additive oils derived from coal tar and pine tar can also be used. Examples of such oils include, white oil produced from gas to liquid technology such as Risella™ X 415/420/430 (available from Shell of Houston, Tex.); Primol™ 352, Primol™ 382, Primol™ 542, Marcol™ 82, and Marcol™ 52 (available from ExxonMobil of Houston, Tex.); Drakeol® 34 available from Penreco of Karns City, Pa.; or combinations thereof. Oils described in U.S. Pat. No. 5,936,028, which is incorporated herein by reference for U.S. patent practice, may also be employed.

In some embodiments, synthetic oils include polymers and oligomers of butenes including isobutene, 1-butene, 2-butene, butadiene, and mixtures thereof. In some embodiments, these oligomers can be characterized by a number average molecular weight (Mn) in a range from about 300 g/mol to about 9,000 g/mol, and in other embodiments from about 700 g/mol to about 1,300 g/mol. In some embodiments, these oligomers include isobutenyl mer units. Exemplary synthetic oils include polyisobutylene, poly(isobutylene-co-butene), and mixtures thereof. In some embodiments, synthetic oils may include polylinear α-olefins, poly-branched α-olefins, hydrogenated polyalphaolefins, and mixtures thereof. In some embodiments, the synthetic oils include synthetic polymers or copolymers having a viscosity in a range from about 20 cp or more, such as about 100 cp or more or about 190 cp or more, where the viscosity is measured by a Brookfield viscometer according to ASTM D-4402 at 38° C. In these or other embodiments, the viscosity of these oils can be in a range of about 4,000 cp or less, such as about 1,000 cp or less. Useful synthetic oils can be commercially obtained under the trade names Polybutene™ (available from Soltex of Houston, Tex.), Parapol™ (available from ExxonMobil of Houston, Tex.) and Indopol™ (Ineos of League City, Tex.). Oligomeric copolymers including butadiene are commercially available under the trade name Ricon Resin™ (available from Ricon Resins of Grand Junction, Colo.).

The ordinarily skilled chemist will recognize which type of oil should be used with a particular rubber, and also be able to determine the amount (quantity) of oil. The additive oil can be present in amounts in a range from about 5 to about 300 parts by weight per 100 parts by weight of the blend of the rubber and isotactic polypropylene components. The amount of additive oil may also be expressed as in a range from about 30 to 250 parts, such as from about 70 to 200 parts by weight per 100 parts by weight of the rubber component. Alternatively, the quantity of additive oil can be based on the total rubber content, and defined as the ratio, by weight, of additive oil to total rubber in the TPV, and that amount may in certain cases be the combined amount of processing oil (typically added during processing) and extender oil (typically added after processing). The ratio may range, for example, from about 0 to about 4.0/1. Other ranges, having any of the following lower and upper limits, may also be utilized: a lower limit of 0.4/1, or 0.6/1, or 0.8/1, or 1.0/1, or 1.2/1, or 1.5/1, or 1.8/1, or 2.0/1, or 2.5/1; and an upper limit (which may be combined with any of the foregoing lower limits) of 4.0/1, or 3.8/1, or 3.5/1, or 3.2/1, or 3.0/1, or 2.8/1. Larger amounts of additive oil can be used, although the deficit is often reduced physical strength of the composition, oil weeping, or both.

Polymeric processing additives may also optionally be added. These processing additives may include polymeric or oligomeric resins, such as hydrocarbon resins that have a very high melt flow index. These polymeric resins include both linear and branched molecules that have a melt flow rate that is a range of about 500 dg/min or greater, about 750 dg/min or greater, about 1000 dg/min or greater, about 1200 dg/min or greater, or about 1500 dg/min or greater. Mixtures of various branched or various linear polymeric processing additives, as well as mixtures of both linear and branched polymeric processing additives may be used. Examples of useful linear polymeric processing additives include polypropylene homopolymers. Examples of useful branched polymeric processing additives include diene-modified polypropylene polymers. Thermoplastic vulcanizates that include similar processing additives are disclosed in U.S. Pat. No. 6,451,915, which is incorporated herein by reference.

Certain embodiments include hydrocarbon resins produced from petroleum-derived hydrocarbons and monomers of feedstock including tall oil and other polyterpene or resin sources. The terms “hydrocarbon resin” or “resin molecule” are interchangeable as used herein. Hydrocarbon resins are generally derived from petroleum streams, and may be hydrogenated or non-hydrogenated resins. The hydrocarbon resins may be polar or non-polar. “Non-polar” means that the HPA is substantially free of monomers having polar groups. Such hydrocarbon resins may include substituted or unsubstituted units derived from cyclopentadiene homopolymer or copolymers, dicyclopentadiene homopolymer or copolymers, terpene homopolymer or copolymer, pinene homopolymer or copolymers, C₅ fraction homopolymer or copolymer, C₉ fraction homopolymer or copolymers, alpha-methylstyrene homo or copolymers, and combinations thereof. Examples of hydrocarbon resins include aliphatic hydrocarbon resins such as resins resulting from the polymerization of monomers consisting of olefins and diolefins (e.g., ESCOREZ™ and Oppera™ from ExxonMobil Chemical Company, Houston, Tex. or PICCOTAC 1095 from Eastman Chemical Company, Kingsport, Tenn.) and the hydrogenated derivatives thereof: alicyclic petroleum hydrocarbon resins and the hydrogenated derivatives thereof (e.g. ESCOREZ 5300 and 5400 series from ExxonMobil Chemical Company; EASTOTAC resins from Eastman Chemical Company). Other exemplary resins useful in the present TPV compositions include, the hydrogenated cyclic hydrocarbon resins (e.g. REGALREZ and REGALITE resins from Eastman Chemical Company). In some embodiments, the resin has a Ring and Ball (R&B) softening point equal to or greater than 80° C. The Ring and Ball (R&B) softening point can be measured by the method described in ASTM E28, which is incorporated herein by reference.

In some embodiments, for nitrile elastomer based TPV or TPE, plasticizers can be phthalate plasticizers, such as polyester-based plasticizers, adipate-based plasticizers, sebacate plasticizers and the like. Commonly used phthalate based plasticizers include di-isodecyl phthalate, di-isononylphthalates, dibutyl phthalate (DBP), isooctyl phthalate (DOP), diisobutyl phthalate (DIBP), phthalic acid di (2-ethylhexyl) ester (DOP), bis 1,4-(2-ethylhexyl) cyclohexane dicarboxylate, 1,2- or 1,4-dialkyl cyclohexane dicarboxylate, propylene glycol adipic acid type polyester plasticizers. Exemplary phthalate based plasticizers include those from ExxonMobil available under the tradename Jayflex®, and from Eastman Chemical Company available under the tradename Eastman™ DOP. Non phthalate based plasticizers can also be used. Preferred examples include bis(2-ethylhexyl) terephthalate based plasticizers available under the tradename Eastman 168 (from Eastman), and Bis(2-Ethylhexyl) Adipate available under the tradename Eastman™ DOA.

### Preparation of TPE or TPV Blends

### Sample Preparation Using a Brabender Mixer

Thermoplastic vulcanizate preparation can be carried out under nitrogen in any suitable mixer, such as a laboratory Brabender-Plasticorder (model EPL-V5502). For example, the mixing bowls can have a capacity of 85 ml with the cam-type rotors employed. The plastic can be initially added to the mixing bowl that can be heated to 180° C. and at 100 rpm rotor speed. After plastic melting (2 minutes), the rubber, inorganic additives, compatibilizers (premade) and processing oil/plasticizers can be packed into the mixer. If an in situ compatibilizer system is employed, the individual components forming the graft copolymer blended in along with the plastic and rubber components. After homogenization of the molten polymer blend (in 3-4 minute a steady torque can be obtained), the curative can be added to the mix, which can cause a rise in the motor torque.

Mixing can be continued for several more minutes, such as about 4 more minutes, after which the molten TPV can be removed from the mixer, and pressed when hot between Teflon plates into a sheet which can be cooled, cut-up, and compression molded at a temperature, for example about 400° F. For example, a Wabash press, model 12-1212-2 TMB can be used for compression molding, with 4.5″×4.5″×0.06″ mold cavity dimensions in a 4-cavity Teflon-coated mold. Material in the mold can be initially preheated at a temperature, such as about 400° F. (204.4° C.) for a time, such as about 2-2.5 minutes, and at a pressure, such as at a 2-ton pressure on a 4″ ram, after which the pressure can be increased, such as to about 10-tons, and heating can be continued, such as for about 2-2.5 minutes more. The mold platens were then cooled with water, and the mold pressure can be released after cooling (140° F.). Dog-bones can be cut out of the molded (aged at room temperature for 24 hours) plaque for tensile testing (0.16″ width, 1.1″ test length (not including tabs at end)).

### Sample Preparation Using a Twin Screw Extruder (TSE)

The following description explains the process employed in the following samples unless otherwise specified. A co-rotating, fully intermeshing type twin screw extruder, supplied by Coperion Corporation, Ramsey N.J., can be used following a method similar to that described in U.S. Pat. Nos. 8,011,913, 4,594,390, and US 2011/0028637 (excepting those altered conditions identified here), which are incorporated herein by reference. Rubber can be fed into the feed throat of an extruder, such as a ZSK 53 extruder. The thermoplastic resin can also be fed into the feed throat along with other reaction rate control agents, such as zinc oxide and stannous chloride if applicable. Compatibilizers and fillers can also be added into the extruder feed throat. Processing oil can be injected into the extruder at two different locations along the extruder. The curative can be injected into the extruder after the rubber, thermoplastics and fillers commence blending and after the introduction of first processing oil (pre-cure oil). The curative may also be injected with the processing oil, which oil may or may not be the same as the other oil introduced to the extruder or the oil the rubber is extended with. A second processing oil (post-cure oil) can be injected into the extruder after the curative injection. Rubber crosslinking reactions can be initiated and controlled by balancing a combination of viscous heat generation due to application of shear, barrel temperature set point, use of catalysts, and residence time.

Blends of the present disclosure can be provided by mixing two or more components of the blend using any suitable mixer, such as a continuous mixing reactor, which can also be referred to as a continuous mixer. Continuous mixing reactors can include those reactors that can be continuously fed ingredients and that can continuously have product removed therefrom. Examples of continuous mixing reactors include twin screw or multi-screw extruders (e.g., ring extruder). Methods and equipment for continuously preparing compositions are described in U.S. Pat. Nos. 4,311,628, 4,594,390, 5,656,693, 6,147,160, and 6,042,260, as well as WO 2004/009327 A1, which are incorporated herein by reference, although methods employing low shear rates can also be used. The temperature of the blend as it passes through the various barrel sections or locations of a continuous reactor can be varied. Other suitable mixing equipment can include roll mills, stabilizers, Banbury mixers, Brabender mixers, mixing extruders and the like. Multiple-step processes can also be employed similar to a process whereby ingredients, such as additional additives, are added after a vulcanization process as disclosed in International Application No. PCT/US04/30517. Here, additional additives may be added to an elastomer-polymer blend of the present disclosure before or after post-extrusion crosslinking.

### Fabrication and Crosslinking of Flexible Pipes Incorporating a TPE or TPV

In one embodiment, the crosslinkable TPE or TPV blend is a co-extruded layer comprising two or more co-extruded polymer sub layers of equal or different material compositions. These co-extruded sublayers may be crosslinked in one stage, whereby the material sub layers will bind to each other. Thus, in one embodiment a polymer layer comprises co-extruded sub layers in the form of an innermost sublayer of a crosslinked elastomer-polymer blend with a higher amount of fillers, and an outermost sublayer of a crosslinked elastomer-polymer blend with a lower amount of fillers.

According to the present disclosure, the crosslinking of the TPE or TPV blend is initiated by a crosslinking agent serving as a radical-former when activated. A crosslinking agent decomposes at a specific temperature (e.g., the activation temperature of the peroxide). Exemplary crosslinking agents according to the present disclosure may also decompose if they are exposed to certain electromagnetic wavelengths, e.g. microwave or infrared light. Optionally, in one embodiment, the TPE or TPV blend is not crosslinked prior to extrusion of the inner pressure sheath. Crosslinking of the TPE or TPV blend before extrusion and/or during extrusion is undesired because during extrusion it will make the extrusion more difficult and preventing the extrudate to flow through the die shutting off the operation. However, including a crosslinking agent in the TPE or TPV blend during the extrusion provides mixing of the crosslinking agent in the TPE or TPV blend in preparation for a post-extrusion curing stage, which improves the thermoset properties of the crosslinked TPE or TPV blend.

For example, without being bound by theory, decomposition causes a crosslinking agent to release radical-formers which induce crosslinking in the TPE or TPV blend. The crosslinking process could place in the continuous thermoplastic phase, the elastomer phase (if partially crosslinked in the TPE or TPV composition before entering the extruder) or both the thermoplastic and elastomer phases. The temperature during the extrusion is typically between 145° C. to 230° C. The temperature during extrusion is selected to keep the TPE or TPV blend in a molten state. Thus, it may be advantageous to select a crosslinking agent having an activation temperature above 145° C. or even above 150° C. The crosslinking agent can have an activation temperature which is substantially above such as at least 1° C., such as at least 5 to 10° C., above the temperature of the TPE or TPV blend during the extrusion.

In some embodiments, the crosslinking agent is a peroxide with half-life greater than 30 minutes at 120° C., greater than 30 min at 150° C., such as greater than 0.5 min at 180° C. Half-life is a convenient index that represents the decomposition rate of the organix peroxides from the initial active oxygen content of the peroxide to half of that value by decomposition at a specific temperature. Half-life is measured using a solution of 0.1 mol/l of peroxide with a solvent relatively inert to radicals, e.g. benzene, under nitrogen sealed in a glass ampoule, and immersed in a constant temperature bath set to the temperature required.

For example, peroxides with a higher activation temperature include butylcumylperoxide, dicumylperoxide, Trigonox 145B 2,5-dimethyl hexane 2,5-di-t-butyl peroxide, bis(t-butylperoxy isopropyl)benzene, t-butyl cumyl peroxide, di-t-butyl peroxide, 2,5-dimethyl hexine-3 2,5-di-t-butyl peroxide or a hydroperoxide, e.g. butylhydroperoxide.

In some embodiments, the free radical crosslinking agent is a high temperature C—C initiator that undergoes bond scission at high temperatures such as greater than 200° C. Conventional peroxide crosslinking agents typically have a low half-life under typical extrusion conditions. Certain class of free radical initiators based on C—C bond scission shows extraordinarily high half-life

In some embodiments, the C—C initiator has a half-life of greater than 30 min at 230° C., such as greater than 30 min at 250° C. Examples of C—C initiators useful of crosslinking the TPE or TPV compositions of the present disclosure include 2,3-Dimethyl-2,3-diphenylbutan and 3,4-dimethyl-3,4-diphenyl hexane.

In an embodiment, the crosslinking agent is a C—H insertion compound having least two functional groups capable of C—H insertion under reaction conditions.

In an embodiment, the functional azide is selected from the group of alkyl and aryl azides (R—N₃), acyl azides (R—C(O)N₃), azidoformates (R—O—C(O)—N₃), phosphoryl azides ((RO)₂—(PO)—N₃), phosphinic azides (R₂—P(O)—N₃) and silyl azides (R₃—Si—N₃).

In an embodiment, the polyfunctional azides include poly(sulfonyl azide) including at least two sulfonyl azide groups.

In an embodiment, the poly(sulfonyl azide)s have a structure X—R—X wherein each X is SO₂N₃ and R is an unsubstituted or inertly substituted hydrocarbyl, hydrocarbyl ether or silicon-containing group, for example having sufficient carbon, oxygen or silicon, such as carbon, atoms to separate the sulfonyl azide groups sufficiently to permit a facile reaction between the polyolefin and the sulfonyl azide, such as at least 1, such as at least 2, such as at least 3 carbon, oxygen or silicon, such as carbon, atoms between functional groups. While there is no critical limit to the length of R, each R advantageously can have at least one carbon or silicon atom between X's and can have less than about 50, such as less than about 30, such as less than about 20 carbon, oxygen or silicon atoms.

In an embodiment, the polyfunctional azides have a half-life of at least 1 min at 200° C., such as at least 2 min, such as at least 4 min.

In an embodiment, a maleimide-functionalized mono-azide and/or a citraconimide functionalized mono-azide along with a radical scavenger selected from the group consisting of hydroquinone, hydroquinone derivatives, benzoquinone, benzoquinone derivatives, catechol, catechol derivatives, 2,2,6, 6-tetramethylpiperidinooxy (TEMPO), TEMPO derivatives, and combinations can be used for crosslinking polypropylene as the continuous thermoplastic phase as described in U.S. Pub. No. 2018/0086887.

According to the present disclosure, the crosslinking agent may be activated by exposing the extruded TPE or TPV composition to electromagnetic waves, for example infrared radiation and/or microwave.

In an embodiment, the crosslinking agent may be added to the TPE or TPV blend before extrusion, such as downstream of the curative addition during dynamic vulcanization.

In an embodiment, the crosslinking agent may be added to the TPE or TPV blends in a second extrusion step to produce TPV or TPE pellets with pre-incorporated crosslinking agent.

In another embodiment, the crosslinking agent may be added in solid state as powder or granulate. Alternatively the crosslinking agent may be added in liquid form.

The amount of crosslinking agent in the TPE or TPV blend can be at least 0.1% by weight of the blend, such as from about 0.2% to about 3% by weight of the polymer, such as up to about 2%, such as up to about 1.5% by weight of the total polymer composition including peroxide. In at least one embodiment where the crosslinking agent is a peroxide or a C—C initiator, crosslinking of the blend when using infrared radiation for activating the peroxide, the blend contains peroxide from 0.1% to 1.0% by weight, such as from 0.2% to 0.8% by weight of the total polymer.

Processes of the present disclosure include treating the extruded TPE or TPV blend with electromagnetic waves selected from infrared radiation and microwave, e.g. in the range of about 700 nm to about 1 mm, alternatively from about 300 MHz to about 300 GHz. In one embodiment, the extruded blend is exposed to electromagnetic waves for a sufficient time to thereby raise the temperature of the extruded blend at least to the activation temperature of the crosslinking agent. The time for exposing thereby depends on the type of crosslinking agent, the thickness of the blend (e.g., as a layer), the intensity and wavelength of the electromagnetic radiation, as well as the initial temperature of the extruded TPE or TPV blend at its entrance into the crosslinking zone.

The extruded blend is passed to a crosslinking zone to initiate the crosslinking. The crosslinking is initiated by activating the crosslinking agent by use of electromagnetic waves, such as infrared radiation. In one embodiment, the crosslinking is activated by exposing the extruded blend to electromagnetic waves with a wavelength measured in vacuum of from about 400 nm to about 700 nm.

In at least one embodiment, the crosslinking is performed by applying infrared radiation to provide a very fast crosslinking with a high degree of crosslinking when using infrared radiation comprising wavelengths corresponding to the absorption peaks for the crystalline polymer and/or polar elastomer.

The infrared radiation source usable to activate the peroxide may be any suitable type of IR lamp which radiates a suitable amount of infrared radiation, such as with wavelengths as stated above. In one embodiment an infrared lamp with electromagnetic waves in the interval 0.5-5.0 m and with a peak around 1.2 m is used. The infrared radiation source can be placed in the crosslinking zone in such a way that all parts of the extruded TPE or TPV blend are exposed to infrared radiation.

In one embodiment, the electromagnetic wave generating apparatus in the crosslinking zone is arranged in such a way that the TPE or TPV blend is subjected to electromagnetic waves from all sides or angles in the crosslinking zone. For instance, when the TPE or TPV blend has a circular cross section, the electromagnetic wave generating apparatus is placed all around the circumference of the cross-section to provide heat to the TPE or TPV blend.

The time for performing the crosslinking in the crosslinking zone can depend on the thickness of the TPE or TPV blend (layer), the type of crosslinking used includes its activating temperature, and the method used for activating the crosslinking agent in the crosslinking zone. In some applications, the crosslinking time may be relatively long, e.g. 10 minutes or even longer, but in order to optimize the in-line process and the space occupied by the crosslinking zone, the time for performing the crosslinking might be adjusted to be about the time for extruding 0.05 m to 2 m, such as 0.2 m to 1 m of the TPE or TPV blend (layer). This adjustment may be performed by regulating the application of heat, the selection of type of peroxide, and the thickness of the extruded polymer. Also the extrusion velocity may be adjusted.

In one embodiment, crosslinking includes the use of infrared heaters or microwaves as heating means, the extruded material is subjected to a heat treatment in the crosslinking zone for up to about 600 seconds, such as about 5 seconds to about 120 seconds, such as about 10 seconds to about 60 seconds.

In one embodiment, the extruded TPE or TPV blend is subjected to a heat treatment in the crosslinking zone at a temperature above 145° C., such as at a temperature from 150° C. and 250° C. to activate the crosslinking agent.

When infrared heating lamps are used according to the present disclosure, this has the advantage that the crosslinking agent may be activated simultaneously by infrared light and heat. Hereby, an excellent and rapid crosslinking can be obtained.

In an embodiment, the extruded TPE or TPV composition is crosslinked with the use of electron beam radiation or e-beam.

In an embodiment, the pressure in the crosslinking zone is raised above ambient pressure. By increasing the pressure in the crosslinking zone, formation of bubbles and irregularities in the TPE or TPV blend can be reduced or eliminated/avoided. The pressure can be raised to 1.5 bars above ambient pressure, such as 2 bars above ambient pressure, and typically the pressure in the crosslinking zone is between 2.5 and 10 bars.

In order to reduce or eliminate/avoid deformation or reactions in the extruded TPE or TPV blend, the extruded TPE or TPV blend can enter the crosslinking zone immediately after extrusion or no later than about 5 minutes or even 2 minutes after extrusion. By passing the extruded TPE or TPV blend from the extruder to the crosslinking zone, the temperature of the TPE or TPV blend may be kept close to the extrusion temperature at the entrance to the crosslinking zone, which means that the amount of energy for activating the crosslinking agent can be as low as feasible. For example, the temperature of the TPE or TPV blend at the entrance to the crosslinking zone can be at least 100° C., such as at least 120° C., such as at least 140° C. The entrance is defined as the place between the extruder and the crosslinking zone where the temperature of the TPE or TPV blend is lowest.

Moreover, the velocity of the extrusion of the TPE or TPV blend can be approximately equal to the velocity of the extruded polymer passing through the crosslinking zone, and the velocity can be from about 0.2 m/minute to 2 m/minute, such as from about 0.5 m/minute to 1.0 m/minute.

The extruded TPE or TPV blend from the crosslinking zone can be cooled to ambient temperature, e.g. the TPE or TPV blend may be cooled in a cooling zone with water or air.

The supporting unit may in principle be any kind of supporting apparatus which supports the TPE or TPV blend as it passes out from the extruder. The supporting unit onto which the TPE or TPV blend may be extruded may simply be a mandrel, net or hollow wire. The supporting unit onto which the TPE or TPV blend may be extruded and may be a tube-formed unit, such as a calibrating device (calibrator). Such calibrator is typical for extruding inner liners for flexible unbonded offshore pipes without inner reinforcing layer(s) (carcass). A calibrator may e.g. calibrate the outer dimension of the pipe or tube shaped polymer layer using vacuum suction onto a solid surface e.g. metal surface, which surface may be wetted with water for lubrication.

Thus, in at least one embodiment, the TPE or TPV blend is an inner liner of a flexible unbonded offshore pipe without carcass, and the inner liner is extruded into a supporting unit, such as in the form of a calibrator. In at least one embodiment, the supporting unit is a reinforcement material, and a reinforcement layer of a flexible unbonded offshore pipe.

The supporting unit may be in the form of a carcass, in which case the TPE or TPV blend is an inner liner of a flexible unbonded offshore pipe and the TPE or TPV blend is extruded onto the carcass to form the inner liner.

Where the TPE or TPV blend layer is an intermediate layer of a flexible unbonded offshore pipe, the supporting unit may be in the form of a pressure armor, and the TPE or TPV blend is extruded onto the pressure armor.

Where the TPE or TPV blend is an outer cover of a flexible unbonded offshore pipe, the supporting unit may be in the form of a tensile armor, and the TPE or TPV blend is extruded onto the tensile armor. As used herein, the term “outer cover” does not exclude that further armoring layer or layers are applied around the outer cover.

In one embodiment, the supporting unit material is a metallic material, such as shaped as a carcass, a pressure armor or a tensile armor of metallic material. The metallic material may be capable of reflecting infrared radiation from the infrared radiation source or optionally heat from the heating means in the crosslinking zone, thereby increasing the effect of the infrared radiation or heating on the TPE or TPV blend. This reflective effect will lead to faster and more effective activation of the crosslinking agent and crosslinking of the TPE or TPV blend.

When extruding a polymer layer onto a supporting unit in the form of a carcass or another armor, a secondary layer e.g. a tape or film layer can be applied onto the armor prior to the application of the TPE or TPV blend. Thereby undesired deformation of the TPE or TPV blend due to the shape of the surface of the armor may be avoided. In one embodiment, wherein the supporting unit is an armor layer and the secondary layer comprises a tape applied onto the armor and the TPE or TPV blend is extruded onto this tape, the tape can have a reflecting surface reflecting the infrared radiation or heat applied in the crosslinking zone. The tape may comprise a metallized surface. The reflecting surface of the tape may be capable of reflecting at least 50% of the infrared radiation or heat applied to the tape when using infrared light or infrared heating or microwave heating.

In one embodiment, the TPE or TPV blend (e.g., layer) may comprise a secondary layer below the polymer layer, said secondary layer having a reflective surface reflecting the electromagnetic waves applied in the crosslinking zone. The reflective surface of the secondary layer may be capable of reflecting at least 50% of the not adsorbed electromagnetic waves, which in practice means that the secondary layer is capable of reflecting at least 50% of the electromagnetic waves irradiated at the surface.

In one embodiment, where the supporting unit is an armor layer, the TPE or TPV blend comprises a secondary layer such as a foil applied onto the armor, and the polymer composition is extruded onto this secondary layer. The secondary layer may be a permeation barrier e.g. barrier for liquid or gas, such as methane, hydrogen sulphides and carbon dioxide. Thereby armor layers placed on the outer side of the secondary layer are protected from such aggressive gasses which may be transferred in the pipe.

In at least one embodiment, the tube formed polymer article obtained by a process of the present disclosure is an inner liner of the offshore pipe.

In at least one embodiment, the tube formed polymer article obtained by a process of the present disclosure is at least one of the outer sheath, insulation layer and anti-wear layer of the offshore pipe.

Crosslinking can be initiated in-line (or on-line) with the extrusion of the inner liner. By in-line is meant ‘in the same continuous process stage’. As a result, the liner material completes the crosslinking within the crosslinking zone without any further treatment, and may be before the final multilayer pipe structure is completed.

Crosslinking of the pressure sheath may be terminated prior to the making of the metal armoring and outer sheath and the end fittings. This is advantageous for several reasons. Quality control is made earlier in the production cycle and necessary corrections can be made earlier. Also, it is possible to cut samples from the end of the crosslinked inner liner for measurements of the degree of crosslinking, without having to cut off a section of a pipe and then establish a new end fitting, which is costly and time consuming.

In one embodiment, the TPE or TPV blend and other ingredients including the crosslinking agent may be melted and homogenized in an extruder which feeds the TPE or TPV blend melted into a distributor and a tool, either a crosshead tool or a pipe tool. With a crosshead tool, a metal carcass may be fed into the center of the crosshead tool, and the TPE or TPV blend may be extruded around this metal cylinder. The carcass may be at ambient temperature (cold) or preheated to avoid rapid quenching of the polymer. The pressure sheath thickness may be from 4 mm to 20 mm when using a carcass, and somewhat larger, typically 6 mm to 16 mm without a carcass. However, the thickness of the inner liner may differ from the above values, depending on the contemplated use of the pipe. For some uses, a thickness below 4 mm or 6 mm is sufficient, such as to 2 mm. For other uses, thickness above 10 mm or 16 mm, e.g. 18 mm or more may be used.

After extrusion of the pipe using a crosshead tool into which the carcass is fed, the TPE or TPV blend forms a cylindrical object around the carcass. In one embodiment, the extruded pipe may directly after the extrusion be subjected to the radiation with electromagnetic waves and thereby be crosslinked.

Alternatively, the inner liner may be made without a metallic carcass e.g. using pipe tool (or a crosshead tool), and in this case the extruded object may pass through a calibrator as described above.

After the extrusion, the extruded polymer tube may be passed into a crosslinking zone as described. An example of an in-line crosslinking equipment is described in U.S. Pat. No. 7,829,009, incorporated by reference herein. After cooling of the crosslinked TPE or TPV blend layer e.g. using water, the pipe passes out of the cooling chamber and is optionally dried, typically by a wipe-off device and blowing with air. Then a drawing device, such as a caterpillar device, draws the pipe forward. After the caterpillar, the pipe is spooled on a drum, reel or turntable. The metal armoring and the subsequent extrusion of the outer sheath are normally performed in separate steps.

The present disclosure also relates to a method for the production of a flexible unbonded offshore pipe comprising one or more polymer layers (inner liner, intermediate layer or layers and outer cover) in the form of a tube-formed TPE or TPV blend layer.

In one embodiment, the method includes providing a carcass; applying a secondary layer in the form of a gas permeation barrier layer onto the carcass; applying an inner liner in the form of a crosslinked TPE or TPV blend layer according to the process as described above, wherein the TPE or TPV blend is applied onto a supporting unit, and applying one or more reinforcing layers onto the inner liner.

In another embodiment, the method includes providing an inner liner in the form of a polymer layer according to the process as described above, wherein the TPE or TPV blend is applied into a supporting unit; applying a secondary layer in the form of a gas permeation layer onto the inner liner; applying one or more reinforcing layers onto the inner layer.

The secondary layer may be IR reflective as described above. The gas permeation barrier layer may be in the form of a foil, such as a metal foil, or in the form of a polymer. The permeation barrier layer means a layer of a material which provides a higher permeation barrier, such as 50% higher, such as 100% higher such as 500% higher barrier than the inner liner against hydrogen sulphides, and also against methane and carbon dioxides. In one embodiment, the permeation barrier layer is a crosslinked TPE or TPV blend layer. The permeation barrier layer can be thinner than the inner liner such as up to about 50%, such as up to about 20% of the thickness of the inner liner. The permeation barrier layer and the inner liner may be co-extruded and optionally crosslinked.

In one embodiment, the permeation barrier layer is a foil which is wound or bent around the carcass or a removable support tool. The foil may be applied with overlapping edges to thereby form a complete layer. During the crosslinking the foil will adhere or be bonded to the TPE or TPV blend layer, and simultaneously the overlapping edges will be held close together to form a high permeation barrier layer. In one embodiment, the permeation barrier layer is essentially impermeable to one or more of the gasses hydrogen sulphides, methane and carbon dioxide, e.g., at a partial pressure for the respective gasses of 0.03 bar or more, such as 0.1 bar or more, such as 1 bar or more, such as 10 bars or more. In one embodiment, the permeation barrier layer is essentially impermeable to sulphides at a partial pressure of 0.03 bars or more, such as 0.1 bars or more, and to methane at a partial pressure of 1 bar or more, such as 10 bars.

The flexible unbonded offshore pipe may have any shape e.g. as known from WO 00/36324 and U.S. Pat. No. 6,085,799, which are hereby incorporated by reference. One or more of the tube-formed polymer layers, e.g. the inner liner, intermediate layer or layers and/or outer cover, may be produced using the process of the present disclosure.

### Crosslinked TPE or TPV Blend Properties

A crosslinked TPE or TPV blend (e.g., that is a layer of the flexible tube/pipe) of the present disclosure has a degree of crosslinking. The degree of crosslinking of crosslinked TPE or TPV blends of the present disclosure can be from about 20% to about 99%, such as from about 30% to about 99%. The degree of crosslinking can be determined based on a gel content analysis according to ASTM D2765 using xylenes.

In at least one embodiment, a crosslinked TPE or TPV blend (e.g., layer) of the present disclosure has (at a thickness of 4 mm or greater) a carbon dioxide permeability at 80° C. of less than 80 barrers, such as less than 50 barrers, such as less than 25 barrers, such as less than 15 barrers.

In at least one embodiment, the crosslinked TPE or TPV compositions that include a thermoplastic elastomer and a rubber having one or more of the following characteristics: low solubility to CO₂ at 80° C. such as less than 5 cm³ (STP)/cm³·MPa, such as less than 4 cm³ (STP)/cm³·MPa, such as less than 2 cm³ (STP)/cm³·MPa more preferably less than 1 cm³ (STP)/cm³·MPa,

a resistance of up to 20 cycles to blistering at 90° C., 10000 psi using a 90:10 mol % CH₄:CO₂ or 90:10 mol % CO₂:CH₄ and a depressurization rate of 70 bars/min,
a percent tensile elongation at break (23° C.) when exposed to Diesel Oil at 90° C. for 4 weeks of about 200% or greater, such as about 150% or greater, such as about 100% or greater,
a percent retention of tensile strength at yield (23° C.) when exposed to Diesel Oil at 90° C. for 4 weeks of greater than 50%, greater than 70%, such as greater than 90%, for example 100%,
a percent weight gain change when exposed to Diesel Oil at 90° C. for 4 weeks less than 30%, less than 25%, less than 20%, such as for example 15%,
a percent tensile elongation at break (23° C.) when exposed to aqueous solution of 18% calcium chloride and 14% calcium bromide at 90° C. for 4 weeks of about 200% or greater, such as about 150% or greater, such as about 100% or greater,
a percent retention of tensile strength at yield (23° C.) when exposed to aqueous solution of 18% calcium chloride and 14% calcium bromide at 90° C. for 4 weeks of greater than 50%, greater than 70%, such as greater than 90%, for example 100%,
a percent weight gain change when exposed to aqueous solution of 18% calcium chloride and 14% calcium bromide at 90° C. for 4 weeks less than 30%, less than 25%, less than 20%, such as for example 15%,
a percent tensile elongation at break (23° C.) when exposed to sea water at 90° C. for 4 weeks of about 200% or greater, such as about 150% or greater, such as about 100% or greater,
a percent retention of tensile strength at yield (23° C.) when exposed to sea water at 90° C. for 4 weeks of greater than 50%, greater than 70%, such as greater than 90%, for example 100%,
a percent weight gain change when exposed to sea water at 90° C. for 4 weeks less than 30%, less than 25%, less than 20%, such as for example 15%,
a percent tensile elongation at break (23° C.) when exposed to methanol at 90° C. for 4 weeks of about 200% or greater, such as about 150% or greater, such as about 100% or greater,
a percent retention of tensile strength at yield (23° C.) when exposed to methanol at 90° C. for 4 weeks of greater than 50%, greater than 70%, such as greater than 90%, for example 100%,
a percent weight gain change when exposed to methanol at 90° C. for 4 weeks less than 30%, less than 25%, less than 20%, such as for example 15%,
a percent tensile elongation at break (23° C.) when exposed to IRM 903 at 90° C. for 4 weeks of about 200% or greater, such as about 150% or greater, such as about 100% or greater,
a percent retention of tensile strength at yield (23° C.) when exposed to IRM 903 at 90° C. for 4 weeks of greater than 50%, greater than 70%, such as greater than 90%, for example 100%,
a percent weight gain change when exposed to IRM 903 at 90° C. for 4 weeks less than 30%, less than 25%, less than 20%, such as for example 15%,
tensile yield strength at 23° C. greater than 15 MPa, preferably greater than 20 MPa, excellent ductility properties such as tensile strain greater than 10%, greater than 15%, tensile modulus less than 1100 MPa.

Crosslinked TPE or TPV blends (e.g., layers) of the present disclosure can have a fatigue resistance (at a thickness of 4 mm or greater) at 23° C. of up to 500,000 cycles, such as up to 750,000 cycles, such as up to 1,000,000 cycles, such as up to 1,200,000 cycles, such as up to 1,400,000 cycles. Crosslinked TPE or TPV blends (e.g., layers) of the present disclosure can have a fatigue resistance (at a thickness of 4 mm or greater) at 85° C. of up to 500,000 cycles, such as up to 750,000 cycles, such as up to 1,000,000 cycles, such as up to 1,200,000 cycles, such as up to 1,400,000 cycles.

In some embodiments, a crosslinked TPE or TPV blend (e.g., layer) of the present disclosure has (at a thickness of 4 mm or greater) one or more of the following characteristics:

1) A carbon dioxide (CO₂) permeability of about 70 barrers or less, such as about 50 or less, such as about 40 or less, such as about 25 or less, such as about 20 or less, such as about 15 or less.

2) A low solubility to CO₂ at 80° C. such as less than 5 cm³ (STP)/cm³·MPa, such as less than 4 cm³ (STP)/cm³·MPa, such as less than 2 cm³ (STP)/cm³·MPa more preferably less than 1 cm³ (STP)/cm³·MPa.

CO₂ Gas permeability can be measured according to ISO 2782-1: 2012(E) in which the thickness of each sample is measured at 5 points homogeneously distributed over the sample permeation area. The test specimen is bonded onto the holders with suitable adhesive cured at the test temperature. The chamber can be evacuated by pulling vacuum on both sides of the film. The high pressure side of the film is exposed to the test pressure with CO₂ gas at 80° C. The test pressure and temperature is maintained for the length of the test, recording temperature and pressure at regular intervals. The sample is left under pressure until steady state permeation has been achieved (3-5 times the time lag (τ)). The diffusion coefficient and solubility coefficient is estimated from the lag time according to the following equation:

$$Permeability coefficient ( P ) = Diffusion coefficient ( D ) \times Solubility ( S )$$

$$D = \frac{{l}^{2}}{6 τ} ,$$

where 1 is thickness of the sample.

A resistance of up to 20 cycles to blistering at 90° C., 10000 psi using a 90:10 mol % CH₄:CO₂ or 90:10 mol % CO₂:CH₄ and a depressurization rate of 70 bars/min, tensile yield strength at 23° C. greater than 15 MPa, preferably greater than 20 MPa, excellent ductility properties such as tensile strain greater than 10%, greater than 15%, tensile modulus less than 1200 MPa.

In the above characteristics, tensile yield strength, and tensile modulus is measured according to ASTM D638 at 23° C., elongation is measured according to ASTM D638 at 23° C., hardness is measured according to ASTM D2240 and.

The percent weight change is measured according to ASTM D471 and according to API 17B and 17J after exposure to different test fluids at 90° C.

### End Uses

As described above, crosslinked TPE or TPV blends of the present disclosure can be used as layers, e.g. pressure sheath layers, for offshore flexible pipes at operational temperatures, e.g., up to about 60° C., such as up to about 90° C. Crosslinked TPE or TPV blends of the present disclosure can have properties for use as inner liners. The pressure sheath may be a co-extruded layer comprising two or more sub layers e.g. different compositions of the present disclosure.

Processes of the present disclosure may be used for the production of any one of the polymer layers of a flexible offshore pipe. Polymer layers include one or more crosslinked TPE or TPV blends. These polymer layers may be in the shape of a tube (e.g., “tubular”). A flexible offshore pipe is also denoted as an unbonded pipe, which means that the pipe comprises two or more layers which are not bonded along their entire length so that the individual layers can slide with respect to each other. This feature gives the offshore pipe a high flexibility. Typically, the flexible submarine pipe comprises, from the outside inwards: an outer polymeric sealing sheath, at least one ply of tensile armor (usually two), a pressure vault, an internal sealing sheath polymer, optionally a metal carcass, and optionally one or more cladding(s), polymer(s), intermediate seal(s) between two adjacent layers, provided that at least one of these layers comprises a crosslinked TPV or TPE based on the compositions described below.

The layer comprising a crosslinked TPV or TPE is at least one of the layers (usually a polymeric sheath) of the flexible pipe. The flexible submarine pipe may comprise other layers in addition to those mentioned above. For example, the pipe may comprise: a collar carried by the short-pitch winding of at least one cross-sectional wire around the pressure vault to increase the resistance to the pipe bursting, and/or retaining layer such as a high strength aramid strip (Technora® or Kevlare) between the outer polymeric sheath and the tensile armor plies, or between two tensile armor plies, and/or and optionally an anti-wear layer of polymeric material such as plasticized polyamide. Antiwear layers, which are well known to those skilled in the art, are generally carried out by helically winding one or more strips obtained by extrusion of a polymeric material based on polyamide, polyolefin, or PVDF. It may also be made according to WO 2006/120320 which discloses anti-wear layers of ribbons polysulfone (PSU), polyethersulfone (PES), polyphenylsulfone (PPSU), polyetherimide (PEI), polytetrafluoroethylene (PTFE), polyetheretherketone (PEEK) or polyphenylene sulfide (PPS). In a flexible submarine pipe according to the invention, the layer comprising a crosslinked TPV or TPE: the inner polymeric sealing sheath, and/or one or more sheath(s), polymer(s), intermediate(s), situated seal(s) between two other adjacent layers, and/or the outer polymeric sheath sealing. In one embodiment, the polymeric sheath sealing located between two other adjacent layers and comprising a crosslinked TPE or TPV is an anti-wear layer. The layer comprising a crosslinked TPV or TPE undergoes less blistering and can be particularly adapted for use as a polymeric sealing sleeve (to avoid on the one hand the leakage of hydrocarbons into the sea through cracks or blisters formed and secondly the entry of sea water in the pipe). For example, a flexible pipe of the present disclosure may comprise, from the outside inwards: an outer polymeric sheath sealing, at least one ply of tensile armor, a pressure vault, a polymeric sheath internal seal comprising a crosslinked TPE or TPV, and optionally a metal carcass.

In another example, a flexible pipe may comprise, from the outside inwards: an outer polymeric sheath comprising a crosslinked TPE or TPV, at least one ply of tensile armor, a pressure vault, an inner polymeric sealing sheath, and optionally a metal carcass.

In another example, a flexible pipe may comprise, from the outside inwards: an outer polymeric sheath, at least one ply of tensile armor, a pressure vault, a sheath sealing inner polymer, optionally a metal carcass, and one or more duct(s), polymer(s), intermediate(s) sheath comprising a crosslinked TPE or TPV between two adjacent layers. A flexible pipe may also comprise a plurality of layers (typically two or three) comprising a crosslinked TPE or TPV. For example, a flexible pipe may comprise, from the outside inwards: an outer polymeric sheath comprising a crosslinked TPE or TPV, at least one ply of tensile armor, a pressure vault an internal sealing sheath polymer comprising a crosslinked TPE or TPV, and optionally a metal carcass.

Articles and uses for the crosslinked TPE or TPV blends can be in the form of a monolayer film, multilayer film, monolayer sheet, multilayer sheet, and receptacles (e.g., containers and casings).

FIG. 1 is an exploded perspective view of a flexible pipe 100 according to some embodiments. The flexible pipe comprises from inside out an inner sheath 5, a first armor layer 4, at least one intermediate sheath (antiwear layer or an insulation layer) 3, a second armor layer 2, and an outer sheath 1. During use of the flexible pipe, inner sheath 5 contacts the oil and/or gas. The inner sheath 5, intermediate sheath 3, and/or outer sheath 1 are made from or comprise one or more layers, the one or more layers made from a material that can be or include one or more crosslinked TPE or TPV blends. The first armor layer 4 provides strength to the tube and can be made from, for example, one or more layers of metal and/or reinforced polymer (e.g., carbon nanotube reinforced polyvinylidene fluoride (PVDF)). Intermediate sheath 3 provides thermal insulation. Second armor layer 2 provides strength and pressure resistance to the tube and can be made from, for example, one or more layers of metal. Outer sheath 1 protects the pipe structure and has the properties of abrasion resistance and fatigue resistance.

Conventional materials used for polymeric sheaths for fluid containment (e.g., inner sheath 5, intermediate sheath 3, and outer sheath 1) include nylons such as nylon PA11, crosslinked polyethylene, HDPE, PVDF, and nylon PA12. However, conventional materials show deficiencies in resistance to physical, chemical degradation, and resistance to hydrolysis. Conventional materials also show poor crack propagation strength (particularly PA11 and HDPE), permeability to various gases in the fluids being transferred, poor blistering resistance, fatigue strength, and deformability. Crosslinked TPE or TPV blends of the present disclosure can provide an alternative and more robust material for polymeric sheaths for fluid containment.

Disclosed herein is employing the crosslinked TPE or TPV blends in the one or more layers of the inner sheath, intermediate sheath, and/or outer sheath of a flexible pipe. In addition, crosslinked TPE or TPV blends can be used as one or more layers in a thermoplastic umbilical hose. Use of the crosslinked TPE or TPV blends as the one or more layers of inner sheath, intermediate sheath, and/or outer sheath of a flexible pipe or thermoplastic umbilical hose has various benefits including good resistance to chemical and physical degradation, good resistance to hydrolysis, low permeability to various gases in the fluids transported, and substantial resistance to blistering.

FIG. 2 is an exploded perspective view of an unbonded flexible pipe 200 according to some embodiments. The unbonded flexible pipe comprises from inside out a steel carcass 5, an inner sheath 4, pressure armor layers 3 and 3′, an antiwear layer 6, tensile armor layer 2a, insulation layer 7 (an intermediate sheath), tensile armor layer 2b, and an outer sheath 1. Inner sheath 4 and steel carcass 5 contact the oil and/or gas during use. The inner sheath 4 and/or outer sheath 1 are made from or comprise one or more layers, the one or more layers including a material comprising one or more crosslinked TPE or TPV blends. The armor layers 2a and 2b provide strength to the tube and can be made from, for example, one or more layers of metal and/or reinforced polymer (e.g., carbon nanotube reinforced polyvinylidene fluoride (PVDF)). Outer sheath 1 protects the pipe structure and has the properties of abrasion resistance and fatigue resistance.

Overall, methods and blends of the present disclosure provide crosslinked TPE or TPV blends as an alternative and advantageously more robust material both from the performance and material cost viewpoint that can be used in flexible pipes. Crosslinked TPE or TPV blends of the present disclosure are elastomers which can advantageously provide reduced blistering and gas absorption, as compared to crosslinked PE, when used as part of a crosslinked polymer blend layer of a flexible pipe. Such crosslinked TPE or TPV blends also provide substantially improved fatigue properties when compared to crosslinked PE. Elastomers employed can possess substantial polarity to the crosslinked TPE or TPV blends which can substantially improve the resistance to hydrocarbon fluids. Polymers (continuous phase of the crosslinked TPE or TPV blend) of the present disclosure are crystalline polymers which can provide an improved barrier to gases and chemical resistance, as compared to non-crystalline polymers, when used as part of a crosslinked polymer blend layer of a flexible pipe. Crystalline polymers can further provide thermoset properties when present in a crosslinked TPE or TPV blend (e.g., layer) of a flexible pipe.

All documents described herein are incorporated by reference herein, including any priority documents and/or testing procedures to the extent they are not inconsistent with this text. As is apparent from the foregoing general description and the specific embodiments, while forms of the embodiments have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “I” preceding the recitation of the composition, element, or elements and vice versa, e.g., the terms “comprising,” “consisting essentially of,” “consisting of” also include the product of the combinations of elements listed after the term.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present disclosure. Further, all documents and references cited herein, including testing procedures, publications, patents, journal articles, etc. are herein fully incorporated by reference for all jurisdictions in which such incorporation is permitted and to the extent such disclosure is consistent with the description of the present disclosure.

While the present disclosure has been described with respect to a number of embodiments and examples, those skilled in the art, having benefit of the present disclosure, will appreciate that other embodiments can be devised which do not depart from the scope and spirit of the present disclosure as described herein.

1. A flexible pipe comprising a plurality of layers, wherein at least one layer comprises a composition comprising:
at least one polar elastomer, and
a polymer having a crystallinity of about 20% or greater.

2. The pipe of claim 1, wherein the blend comprises fully cured, partially cured, or uncured polar elastomers dispersed in the crystalline polymer.

3. The pipe of claim 1, wherein the blend comprises a crystalline polymer from about 30 wt % to about 90 wt % and the elastomer from about 10 wt % to about 70 wt %, based on the total weight of the elastomer and the polymer.

4. The pipe of claim 1, wherein the elastomer has a polarity of about 100° or less.

5-6. (canceled)

7. The pipe of claim 1, wherein the elastomer is selected from a nitrile rubber, a hydrogenated nitrile rubber, a carboxylated nitrile rubber, an α-olefin-vinyl acetate, an acrylic acid-ester copolymer rubber, and a fluoroelastomeric polymer.

8. (canceled)

9. The pipe of claim 1, further comprising a plasticizer selected from the group consisting of an aromatic mineral oil, paraffinic mineral oil, naphthenic oil, a low molecular weight aliphatic ester, an ether ester plasticizer, polyisobutylene, a phosphate compound, an adipate compound, an alkyl carbitol formal compound, and a coumarone-indene resin.

10. The process of claim 11, wherein crosslinking the extruded composition is conducted by exposing the layer to electron beam radiation.

11. A process for the production of a flexible unbonded offshore pipe comprising at least one polymer layer with a thickness of at least about 4 mm, said method comprising:
shaping composition comprising at least one polar elastomer and a polymer having a crystallinity of about 20% or greater by extruding the composition in an extrusion station and crosslinking the extruded composition, in the presence of a crosslinking agent, said crosslinking agent having an activation temperature substantially above the temperature of the composition during the extrusion thereof; and
crosslinking the extruded composition.

12. (canceled)

13. The pipe of claim 1, wherein the elastomer is an α-olefin-vinyl acetate copolymer that has a vinyl acetate content of 50% or greater by weight.

14. The pipe of claim 13, wherein the blend comprises fully cured, partially cured, or uncured α-olefin-vinyl acetate copolymer dispersed in the crystalline polymer.

15. The pipe of claim 13, wherein the blend comprises a crystalline polymer from about 30 wt % to about 90 wt % and the elastomer from about 10 wt % to about 70 wt %, based on the total weight of the elastomer and the polymer.

16-17. (canceled)

18. The pipe of claim 13, wherein the composition comprises a peroxide cure agent.

19. The pipe of claim 13, wherein the composition comprises a co-crosslinking agent selected from the group consisting of triallylcyanurate, triallyl isocyanurate, triallyl phosphate, sulfur, N-phenyl bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, cyclohexane dimethanol diacrylate ester, polyfunctional methacrylates, acrylate and methacrylate metal salts, and oximes such as quinone dioxime.

20. The pipe of claim 13, wherein the composition further comprises at least one compatibilizer.

21. The pipe of claim 13, further comprising a plasticizer selected from the group consisting of a aromatic mineral oil, paraffinic mineral oil, naphthenic oil, a low molecular weight aliphatic ester, an ether ester plasticizer, polyisobutylene, a phosphate compound, an adipate compound, an alkyl carbitol formal compound, and a coumarone-indene resin.

22-23. (canceled)

24. The pipe of claim 1, wherein:
the elastomer is an uncured or at least partially cured nitrile rubber dispersed in the crystalline polymer, and
the polymer has a crystallinity of about 40% or greater.

25-32. (canceled)

33. The pipe of claim 24, wherein the polymer is a polyethylene with density greater than 0.920 g/cm³.

34-35. (canceled)

36. The pipe of claim 24, wherein the nitrile rubber is crosslinked using a peroxide or a phenolic resin.

37. (canceled)

38. The pipe of claim 24, wherein the composition further comprises a compatibilizer that is the reaction product of maleic anhydride grafted polymer and amine-terminated liquid nitrile rubber.

39. The pipe of claim 24, wherein the composition further comprises processing oils, extenders, or plasticizers.

40-42. (canceled)

43. The pipe of claim 1, wherein:
the elastomer is uncured or at least partially cured, and
the polymer is a polyethylene characterized by raised temperature resistance as a PE-RT Type II material that when evaluated in accordance with ISO 9080 or equivalent, with internal pressure tests being carried out in accordance with ISO 1167-1 and ISO 1167-2, the polyethylene conforms to the 4-parameter model given in ISO 24033 for PE-RT Type II material over a range of temperature and internal pressure as provided in ISO 22391.

44-45. (canceled)

46. The pipe of claim 43, wherein the blend comprises the polyethylene from about 30 wt % to about 90 wt % and the elastomer from about 10 wt % to about 70 wt %, based on the total weight of the elastomer and the polymer.

47. The pipe of claim 43, wherein the elastomer is selected from the group consisting of a polyolefin elastomer, an ethylene alpha olefin diene rubber, a nitrile rubber, a hydrogenated nitrile rubber, an ethylene vinyl acetate, an acrylic acid-ester copolymer rubber, a fluoroelastomeric polymer, a butyl rubber, and a polyisobutylene paramethyl styrene copolymer.

48-64. (canceled)

65. The pipe of claim 1, wherein:
the elastomer is uncured or at least partially cured, and
the polymer is a polyethylene composition with a bimodal molecular weight distribution comprising a low-molecular-weight (LMW) ethylene homopolymer component and a high-molecular-weight (HMW) ethylene copolymer component, or a multimodal polyethylene having:
a density of from 0.930 g/ccm to 0.965 g/ccm,
a melt index (I₂) of from 0.1 to 15.0 gram/10 minute, and
a melt flow ratio (I₂₁/I₂) of from 15 to 90.

66-100. (canceled)

101. A pipe comprising:
an inner sheath;
an outer sheath;
a first armor layer; and
a second armor layer, wherein at least one of the inner sheath and the outer sheath comprises a composition that is the reaction product of an elastomer having a polarity of about 90° or less, a polymer having a crystallinity of about 20% or greater, and a crosslinking agent.

102-121. (canceled)
